(19) United States
(12) Patent Application Publication
(10) Pub. No.: US 2024/0297982 A1
(43) Pub. Date: Sep. 5, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Zhipin Deng, Beijing (CN); Kai Zhang, Los Angeles, CA (US); Li Zhang, Los Angeles, CA (US)

(21) Appl. No.: 18/649,733

(22) Filed: Apr. 29, 2024

Related U.S. Application Data
(63) Continuation of application No. PCT/CN2022/128059, filed on Oct. 27, 2022.

(30) Foreign Application Priority Data
Oct. 28, 2021 (WO) PCT/CN2021/127197

(51) Int. Cl. H04N 19/105; H04N 19/159; H04N 19/167; H04N 19/169; H04N 19/172; H04N 19/176; H04N 19/189; H04N 19/593

(52) U.S. Cl. CPC H04N 19/105; H04N 19/159; H04N 19/167; H04N 19/172; H04N 19/176; H04N 19/1883; H04N 19/189; H04N 19/593

(57) ABSTRACT

Embodiments of the present disclosure provide a solution for video processing. A method for video processing is proposed. The method comprises: determining, during a conversion between a target video block of a video and a bitstream of the video, a first prediction of the target video block by using an inter prediction tool; determining a second prediction by performing a motion compensation process on the first prediction; obtaining a third prediction by performing a forward mapping process on the second prediction; and performing the conversion based on the third prediction.

### CROSS-REFERENCE TO RELATED APPLICATIONS

This application is a continuation of International Application No. PCT/CN2022/128059, filed on Oct. 27, 2022, which claims the benefit of International Application No. PCT/CN2021/127197 filed on Oct. 28, 2021. The entire contents of these applications are hereby incorporated by reference in their entireties.

### FIELD

Embodiments of the present disclosure relates generally to video coding techniques, and more particularly, to motion compensation on prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a target video block of a video and a bitstream of the video, a first prediction of the target video block by using an inter prediction tool; determining a second prediction by performing a motion compensation process on the first prediction; obtaining a third prediction by performing a forward mapping process on the second prediction; and performing the conversion based on the third prediction. The method in accordance with the first aspect of the present disclosure performs a motion compensation process and a forward mapping process on the target video block, and thus improve the coding effectiveness and coding efficiency.

In a second aspect, a method for video processing is proposed. The method comprises: determining, during a conversion between a target video block of a video and a bitstream of the video, a first prediction of the target video block by using an inter prediction tool; obtaining a second prediction by performing a forward mapping process on the first prediction to a reshaped domain; obtaining a third prediction by performing a processing procedure on the second prediction; determining a fourth prediction by performing a motion compensation process at least on the third prediction; and performing the conversion based on the fourth prediction. The method in accordance with the second aspect of the present disclosure performs a forward mapping and a motion compensation process on the target video block, and thus improve the coding effectiveness and coding efficiency.

In a third aspect, a method for video processing is proposed. The method comprises: determining, during a conversion between a target video block of a video and a bitstream of the video, a first prediction of the target video block by using an intra prediction tool; obtaining a second prediction by performing an inverse mapping process on the first prediction to an original domain; obtaining a third prediction by performing a processing procedure on the second prediction; determining a fourth prediction by performing a motion compensation process on the third prediction; and performing the conversion based on the fourth prediction. The method in accordance with the third aspect of the present disclosure performs an inverse mapping process and a motion compensation process on the target video block, and thus improve the coding effectiveness and coding efficiency.

In a fourth aspect, another method for video processing is proposed. The method comprises: determining, during a conversion between a target video block of a video and a bitstream of the video, a plurality of template matching tools for the target video block; applying at least one of the plurality of template matching tools to the target video block; and performing the conversion based on the applying. The method in accordance with the second aspect of the present disclosure allows more than one template matching tools to be used for the target video block, and thus improve the coding effectiveness and coding efficiency.

In a fifth aspect, another method for video processing is proposed. The method comprises: determining, during a conversion between a target video block of a video and a bitstream of the video, coding information of a neighboring coded block of the target video block; and performing the conversion based on the coding information. The method in accordance with the third aspect of the present disclosure uses coding information of a neighboring coded block in the coding of the target video block, and thus improve the coding effectiveness and coding efficiency.

In a sixth aspect, another method for video processing is proposed. The method comprises: determining, during a conversion between a target video block of a video and a bitstream of the video, information regarding a template-based coding tool based on a position of the target video block; and performing the conversion based on the information. The method in accordance with the fourth aspect of the present disclosure determines information regarding the template-based coding tool based on the position of the target video block, and thus improve the coding effectiveness and coding efficiency.

In a seventh aspect, another method for video processing is proposed. The method comprises: determining, during a conversion between a target video block of a video and a bitstream of the video, at least one history-based information table of the target video block; and performing the conversion based on the at least one history-based information table. The method in accordance with the fifth aspect of the present disclosure uses history-based information table of the target video block in coding of the target video block, and thus improve the coding effectiveness and coding efficiency.

In an eighth aspect, an apparatus for processing video data is proposed. The apparatus for processing video data comprises a processor and a non-transitory memory with instructions thereon. The instructions upon execution by the processor, cause the processor to perform a method in accordance with the first, second, third, fourth, fifth, sixth or seventh aspect of the present disclosure.

In a ninth aspect, a non-transitory computer-readable storage medium is proposed. The non-transitory computer-readable storage medium stores instructions that cause a processor to perform a method in accordance with the first, second, third, fourth, fifth, sixth or seventh aspect of the present disclosure.

In a tenth aspect, a non-transitory computer-readable recording medium is proposed. The non-transitory computer-readable recording medium stores a bitstream of a video which is generated by a method performed by a video processing apparatus. The method comprises: determining a first prediction of a target video block of the video by using an inter prediction tool; obtaining a third prediction by performing a forward mapping process on the second prediction; and generating the bitstream based on the third prediction.

In an eleventh aspect, a method for storing a bitstream of a video is proposed. The method comprises: determining a first prediction of a target video block of the video by using an inter prediction tool; obtaining a third prediction by performing a forward mapping process on the second prediction; generating the bitstream based on the third prediction; and storing the bitstream in a non-transitory computer-readable recording medium.

In a twelfth aspect, another non-transitory computer-readable recording medium is proposed. The non-transitory computer-readable recording medium stores a bitstream of a video which is generated by a method performed by a video processing apparatus. The method comprises: determining a first prediction of a target video block of the video by using an inter prediction tool; obtaining a second prediction by performing a forward mapping process on the first prediction to a reshaped domain; obtaining a third prediction by performing a processing procedure on the second prediction; determining a fourth prediction by performing a motion compensation process at least on the third prediction; and generating the bitstream based on the fourth prediction.

In a thirteenth aspect, a method for storing a bitstream of a video is proposed. The method comprises: determining a first prediction of a target video block of the video by using an inter prediction tool; obtaining a second prediction by performing a forward mapping process on the first prediction to a reshaped domain; obtaining a third prediction by performing a processing procedure on the second prediction; determining a fourth prediction by performing a motion compensation process at least on the third prediction; generating the bitstream based on the fourth prediction; and storing the bitstream in a non-transitory computer-readable recording medium.

In a fourteenth aspect, another non-transitory computer-readable recording medium is proposed. The non-transitory computer-readable recording medium stores a bitstream of a video which is generated by a method performed by a video processing apparatus. The method comprises: determining a first prediction of a target video block of the video by using an intra prediction tool; obtaining a second prediction by performing an inverse mapping process on the first prediction to an original domain; obtaining a third prediction by performing a processing procedure on the second prediction; determining a fourth prediction by performing a motion compensation process on the third prediction; and generating the bitstream based on the fourth prediction.

In a fifteenth aspect, a method for storing a bitstream of a video is proposed. The method comprises: determining a first prediction of a target video block of the video by using an intra prediction tool; obtaining a second prediction by performing an inverse mapping process on the first prediction to an original domain; obtaining a third prediction by performing a processing procedure on the second prediction; determining a fourth prediction by performing a motion compensation process on the third prediction; generating the bitstream based on the fourth prediction; and storing the bitstream in a non-transitory computer-readable recording medium.

In a sixteenth aspect, another non-transitory computer-readable recording medium is proposed. The non-transitory computer-readable recording medium stores a bitstream of a video which is generated by a method performed by a video processing apparatus. The method comprises: determining a plurality of template matching tools for a target video block of the video; applying at least one of the plurality of template matching tools to the target video block; and generating the bitstream based on the applying.

In a seventeenth aspect, a method for storing a bitstream of a video is proposed. The method comprises: determining a plurality of template matching tools for a target video block of the video; applying at least one of the plurality of template matching tools to the target video block; generating the bitstream based on the applying; and storing the bitstream in a non-transitory computer-readable recording medium.

In an eighteenth aspect, another non-transitory computer-readable recording medium is proposed. The non-transitory computer-readable recording medium stores a bitstream of a video which is generated by a method performed by a video processing apparatus. The method comprises: determining coding information of a neighboring coded block of a target video block of the video; and generating the bitstream based on the coding information.

In a nineteenth aspect, a method for storing a bitstream of a video is proposed. The method comprises: determining coding information of a neighboring coded block of a target video block of the video; generating the bitstream based on the coding information; and storing the bitstream in a non-transitory computer-readable recording medium.

In a twentieth aspect, another non-transitory computer-readable recording medium is proposed. The non-transitory computer-readable recording medium stores a bitstream of a video which is generated by a method performed by a video processing apparatus. The method comprises: determining information regarding a template-based coding tool based on a position of a target video block of the video; and generating the bitstream based on the information.

In a twenty-first aspect, a method for storing a bitstream of a video is proposed. The method comprises: determining information regarding a template-based coding tool based on a position of a target video block of the video; generating the bitstream based on the information; and storing the bitstream in a non-transitory computer-readable recording medium.

In a twenty-second aspect, another non-transitory computer-readable recording medium is proposed. The non-transitory computer-readable recording medium stores a bitstream of a video which is generated by a method performed by a video processing apparatus. The method comprises: determining at least one history-based information table of a target video block of the video; and generating the bitstream based on the at least one history-based information table.

In a twenty-third aspect, a method for storing a bitstream of a video is proposed. The method comprises: determining at least one history-based information table of a target video block of the video; generating the bitstream based on the at least one history-based information table; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a schematic diagram of intra prediction modes;

FIG. 5A illustrates a schematic diagram of top references;

FIG. 5B illustrates a schematic diagram of left references;

FIG. 6 illustrates a schematic diagram of discontinuity in case of directions beyond 45°;

FIG. 7A illustrates a schematic diagram of the definition of samples used by PDPC applied to diagonal top-right intra mode;

FIG. 7B illustrates a schematic diagram of the definition of samples used by PDPC applied to diagonal bottom-left intra mode;

FIG. 7C illustrates a schematic diagram of the definition of samples used by PDPC applied to adjacent diagonal top-right intra mode;

FIG. 7D illustrates a schematic diagram of the definition of samples used by PDPC applied to adjacent diagonal bottom-left intra mode;

FIG. 8 illustrates example diagram of four reference lines neighboring to a prediction block;

FIGS. 9A and 9B illustrate examples of sub-partitions;

FIG. 10 illustrates a schematic diagram of matrix weighted intra prediction process;

FIG. 11 illustrates a schematic diagram of positions of spatial merge candidates;

FIG. 12 illustrates a schematic diagram of candidate pairs considered for redundancy check of spatial merge candidates;

FIG. 13 illustrates a schematic diagram of motion vector scaling for temporal merge candidate;

FIG. 14 illustrates a schematic diagram of candidate positions for temporal merge candidates;

FIG. 15A and FIG. 15B illustrate schematic diagrams of MMVD search point;

FIG. 16 illustrates a schematic diagram of an extended CU region used in BDOF;

FIG. 17 illustrates a schematic diagram of an illustration for symmetrical MVD mode;

FIG. 18 illustrates a decoding side motion vector refinement;

FIG. 19 illustrates a schematic diagram of top and left neighboring blocks used in CIIP weight derivation;

FIG. 20 illustrates a schematic diagram of examples of the GPM splits grouped by identical angles;

FIG. 21 illustrates a schematic diagram of uni-prediction MV selection for geometric partitioning mode;

FIG. 22 illustrates a schematic diagram of exemplified generation of a bending weight wo using geometric partitioning mode;

FIG. 23 illustrates a schematic diagram of reference samples with padding for OBMC;

FIG. 24 illustrates a schematic diagram of a low-frequency non-separable transform (LFNST) process;

FIG. 25 illustrates examples of SBT position, type and transform type;

FIG. 26 illustrates examples of the ROI for LFNST16;

FIG. 27 illustrates examples of the ROI for LFNST8;

FIG. 28 illustrates a schematic diagram of a discontinuity measure;

FIG. 29 illustrates a schematic diagram of luma mapping with chroma scaling architecture;

FIG. 30 illustrates a flowchart of a method for video processing in accordance with some embodiments of the present disclosure;

FIG. 31 illustrates a flowchart of another method for video processing in accordance with some embodiments of the present disclosure;

FIG. 32 illustrates a flowchart of another method for video processing in accordance with some embodiments of the present disclosure;

FIG. 33 illustrates a flowchart of another method for video processing in accordance with some embodiments of the present disclosure;

FIG. 34 illustrates a flowchart of another method for video processing in accordance with some embodiments of the present disclosure;

FIG. 35 illustrates a flowchart of another method for video processing in accordance with some embodiments of the present disclosure;

FIG. 36 illustrates a flowchart of another method for video processing in accordance with some embodiments of the present disclosure; and

FIG. 37 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

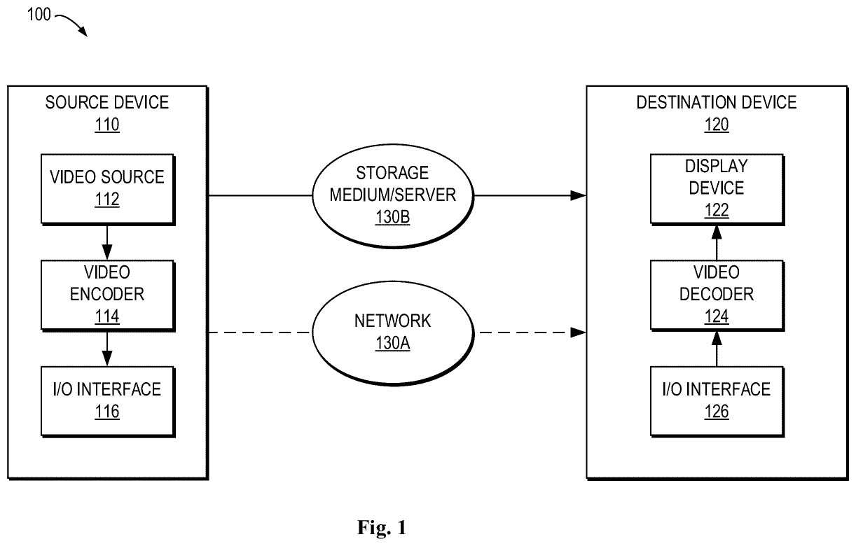

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

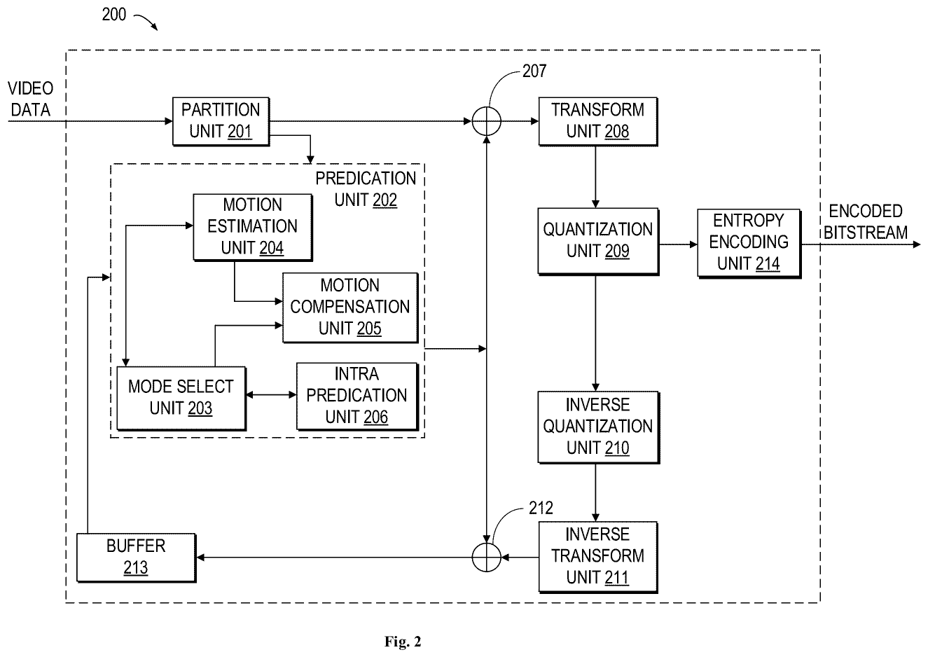

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

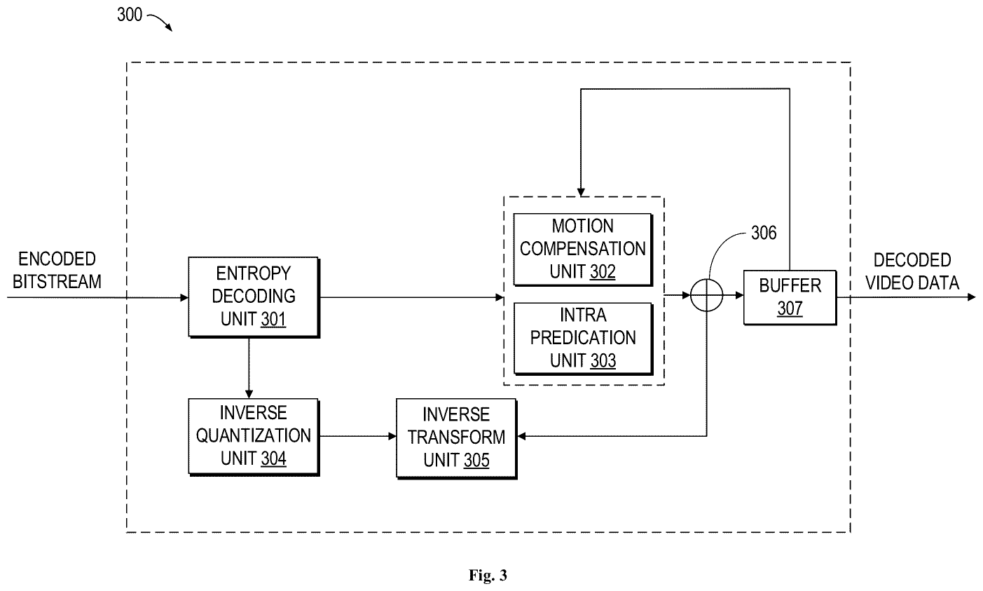

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to video coding technologies. Specifically, it is about inter and intra prediction in image/video coding. It may be applied to the existing video coding standard like HEVC, VVC, and etc. It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. Coding Tools

### 2.1.1. Intra Prediction

2.1.1.1. Intra Mode Coding with 67 Intra Prediction Modes

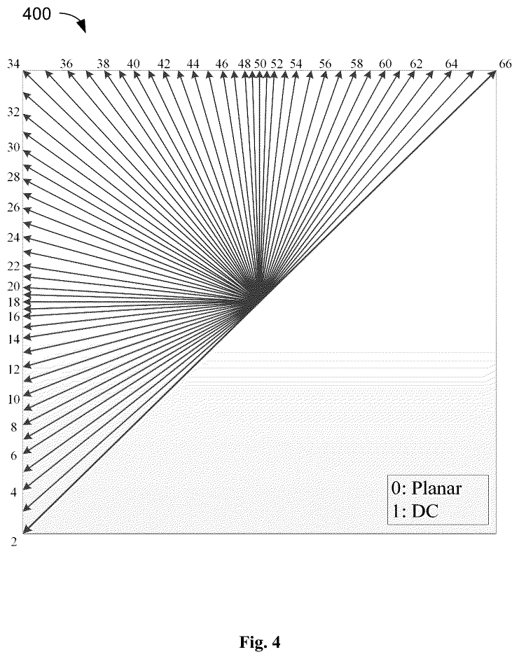

To capture the arbitrary edge directions presented in natural video, the number of directional intra modes in VVC is extended from 33, as used in HEVC, to 65. FIG. 4 illustrates a schematic diagram 400 of intra prediction modes. The new directional modes not in HEVC are depicted as dotted arrows in FIG. 4, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.1.1.2 Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes,
Neighbouring intra modes,
Derived intra modes.

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}.
If one of modes Left and Above is angular mode, and the other is non-angular:
   Set a mode Max as the larger mode in Left and Above,
   MPM list→{Planar, Max, DC, Max−1, Max+1, Max−2}.
If Left and Above are both angular and they are different:
   Set a mode Max as the larger mode in Left and Above,
   if the difference of mode Left and Above is in the range of 2 to 62, inclusive
      MPM list→{Planar, Left, Above, DC, Max−1, Max+1}.
   Otherwise
      MPM list→{Planar, Left, Above, DC, Max−2, Max+2}.
If Left and Above are both angular and they are the same:
   MPM list→{Planar, Left, Left−1, Left+1, DC, Left−2}.

Besides, the first bin of the mpm index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### 2.1.1.3 Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

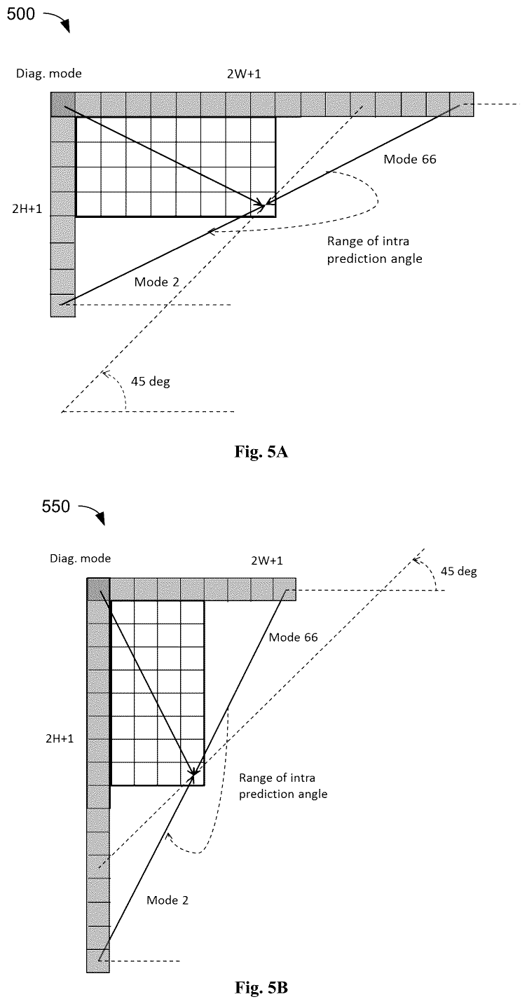

FIG. 5A illustrates a schematic diagram 500 of top reference. FIG. 5B illustrates a schematic diagram 550 of left reference. To support these prediction directions, the top reference with length 2W+1 is defined as reference as shown in FIG. 5A, and the left reference with length 2H+1 is defined as reference as shown in FIG. 5B.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == ½ | Modes 61, 62, 63, 64, 65, 66 |
| W/H == ¼ | Mode 57, 58, 59, 60, 61, 62, 63, 64, 65, 66 |
| W/H == ⅛ | Modes 55, 56 |
| W/H == 1/16 | Modes 53, 54, 55, 56 |

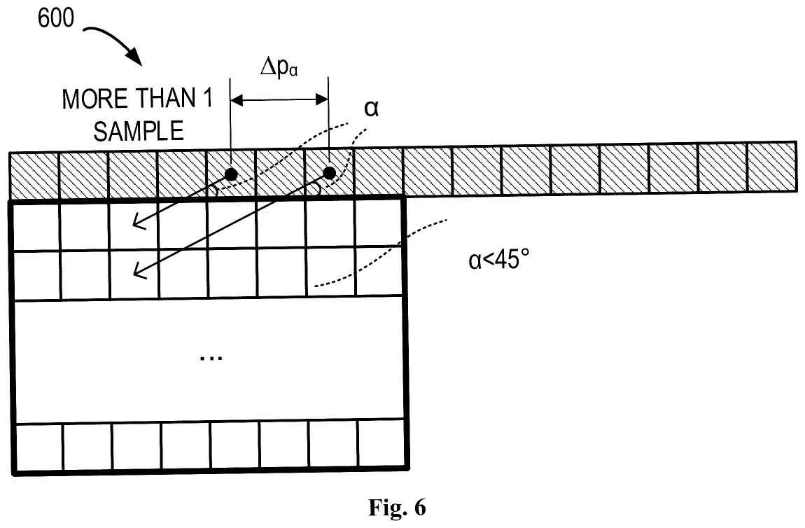

FIG. 6 illustrates a schematic diagram 600 of discontinuity in case of directions beyond 45°. As shown in FIG. 6, two vertically-adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore chroma DM derivation table for 4:2:2: chroma format is updated by replacing some values of the entries of the mapping table to convert prediction angle more precisely for chroma blocks.

### 2.1.1.4 Mode Dependent Intra Smoothing (MDIS)

Four-tap intra interpolation filters are utilized to improve the directional intra prediction accuracy. In HEVC, a two-tap linear interpolation filter has been used to generate the intra prediction block in the directional prediction modes (i.e., excluding Planar and DC predictors). In VVC, simplified 6-bit 4-tap Gaussian interpolation filter is used for only directional intra modes. Non-directional intra prediction process is unmodified. The selection of the 4-tap filters is performed according to the MDIS condition for directional intra prediction modes that provide non-fractional displacements, i.e. to all the directional modes excluding the following: 2, HOR_IDX, DIA_IDX, VER_IDX, 66.

Depending on the intra prediction mode, the following reference samples processing is performed:
The directional intra-prediction mode is classified into one of the following groups:
   vertical or horizontal modes (HOR_IDX, VER_IDX),
   diagonal modes that represent angles which are multiple of 45 degree (2, DIA_IDX, VDIA_IDX),
   remaining directional modes;
If the directional intra-prediction mode is classified as belonging to group A, then then no filters are applied to reference samples to generate predicted samples;
Otherwise, if a mode falls into group B, then a [1, 2, 1] reference sample filter may be applied (depending on the MDIS condition) to reference samples to further copy these filtered values into an intra predictor according to the selected direction, but no interpolation filters are applied;
Otherwise, if a mode is classified as belonging to group C, then only an intra reference sample interpolation filter is applied to reference samples to generate a predicted sample that falls into a fractional or integer position between reference samples according to a selected direction (no reference sample filtering is performed).

### 2.1.1.5 Position Dependent Intra Prediction Combination

In VVC, the results of intra prediction of DC, planar and several angular modes are further modified by a position dependent intra prediction combination (PDPC) method. PDPC is an intra prediction method which invokes a combination of the un-filtered boundary reference samples and HEVC style intra prediction with filtered boundary reference samples. PDPC is applied to the following intra modes without signaling: planar, DC, horizontal, vertical, bottom-left angular mode and its eight adjacent angular modes, and top-right angular mode and its eight adjacent angular modes. The prediction sample pred(x′y′) is predicted using an intra prediction mode (DC, planar, angular) and a linear combination of reference samples according to the Equation 3-8 as follows:

$$\\ \begin{matrix}pred ( {x}^{{}_{} ′} , {y}^{{}_{} ′} ) = ( \begin{matrix}wL \times {R}_{- 1 , {y}^{{}_{} ′}} + wT \times {R}_{{x}^{{}_{} ′} , - 1} - wTL \times {R}_{- 1 , - 1} + \\ ( 64 - wL - wT + wTL ) \times pred ( {x}^{{}_{} ′} , {y}^{{}_{} ′} ) + 32\end{matrix} ) >> 6 & ( 2 ‐ 1 )\end{matrix}$$

where R_{x,-1}, R_{-1,y} represent the reference samples located at the top and left boundaries of current sample (x, y), respectively, and R_{-1,-1} represents the reference sample located at the top-left corner of the current block.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical and clipping operation is avoided. For angular modes, pdpc scale factor is adjusted such that range check is not needed and condition on angle to enable pdpc is removed (scale>=0 is used). In addition, PDPC weight is based on 32 in all angular mode cases. The PDPC weights are dependent on prediction modes and are shown in Table 2. PDPC is applied to the block with both width and height greater than or equal to 4.

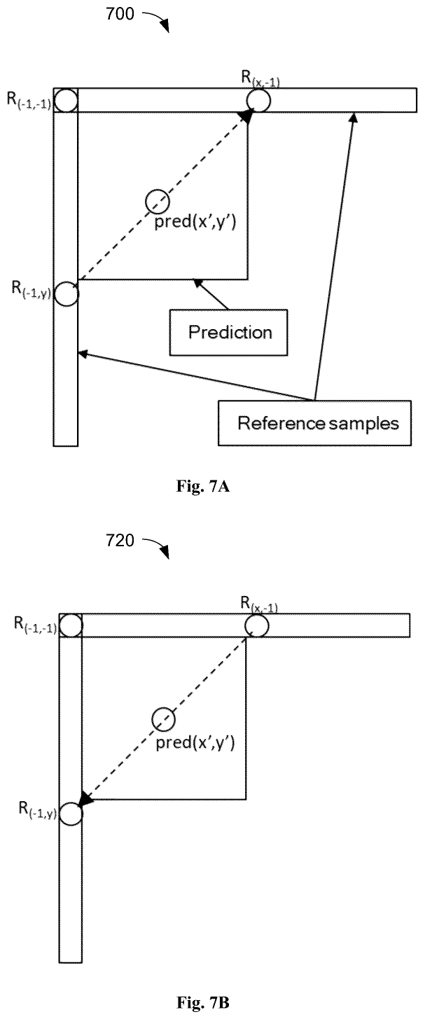

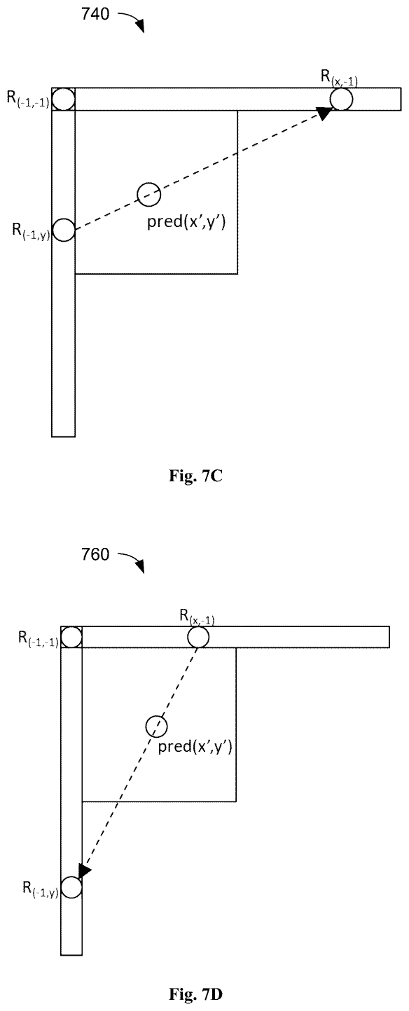

FIG. 7A illustrates a schematic diagram 700 of the definition of samples used by PDPC applied to diagonal top-right intra mode. FIG. 7B illustrates a schematic diagram 720 of the definition of samples used by PDPC applied to diagonal bottom-left intra mode. FIG. 7C illustrates a schematic diagram 740 of the definition of samples used by PDPC applied to adjacent diagonal top-right intra mode. FIG. 7D illustrates a schematic diagram 760 of the definition of samples used by PDPC applied to adjacent diagonal bottom-left intra mode. FIGS. 7A-7D illustrate the definition of reference samples (R_{x,-1}, R_{-1,y} and R_{-1,-1}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other annular mode, the reference samples R_{x,-1} and R_{-1,y} could be located in fractional sample position. In this case, the sample value of the nearest integer sample location is used.

TABLE 2
Example of PDPC weights according to prediction modes

| Prediction modes | wT | wL | wTL |
|---|---|---|---|
| Diagonal | 16 >> ((y′ << | 16 >> ((x′ << | 0 |
| top-right | 1) >> shift) | 1) >> shift) | |
| Diagonal | 16 >> ((y′ << | 16 >> ((x′ << | 0 |
| bottom-left | 1) >> shift) | 1) >> shift) | |
| Adjacent | 32 >> ((y′ << | 0 | 0 |
| diagonal | 1) >> shift) | | |
| top-right | | | |
| Adjacent | 0 | 32 >> ((x′ << | 0 |
| diagonal | | 1) >> shift) | |
| bottom-left | | | |

### 2.1.1.6 Multiple Reference Line (MRL) Intra Prediction

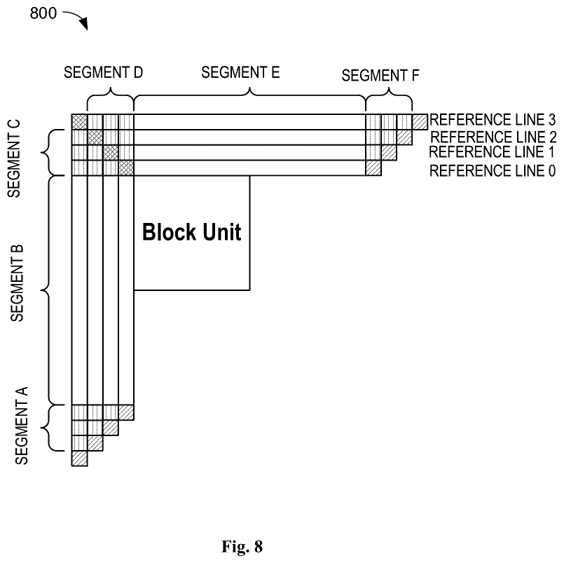

Multiple reference line (MRL) intra prediction uses more reference lines for intra prediction. FIG. 8 illustrates example diagram 800 of four reference lines neighboring to a prediction block. In FIG. 8, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its downsampling filters. The definition of MLR to use the same 3 lines is aligned as CCLM to reduce the storage requirements for decoders.

### 2.1.1.7 Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\\ \frac{M}{2} \times 64 chroma TB s .$$

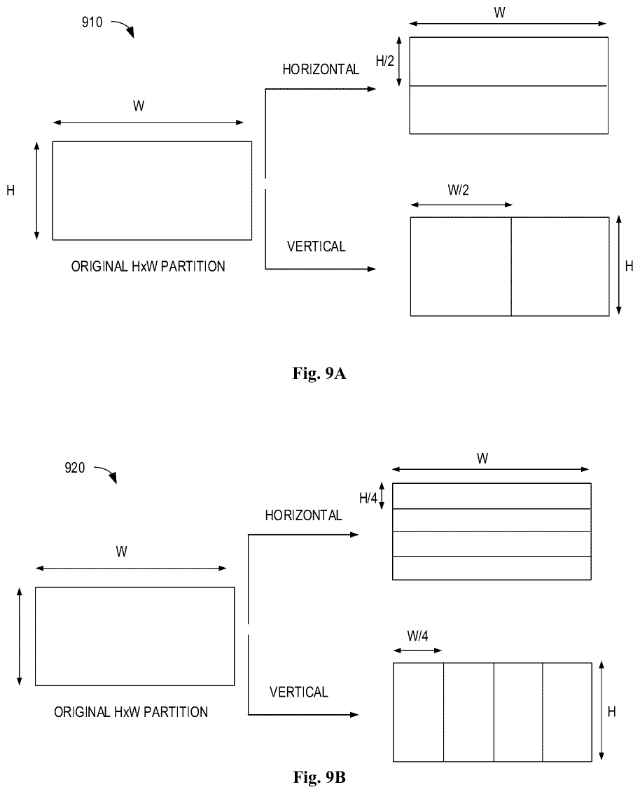

If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIG. 9A illustrates an example diagram 910 illustrating examples of sub-partitions for 4×8 and 8×4 CUs. FIG. 9B illustrates an example diagram 920 illustrating examples of sub-partitions for CUs other than 4×8, 8×4 and 4×4. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 3
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
MPM usage: the MPM flag will be inferred to be one in a block coded by ISP mode, and the MPM list is modified to exclude the DC mode and to prioritize horizontal intra modes for the ISP horizontal split and vertical intra modes for the vertical one.
Transform size restriction: all ISP transforms with a length larger than 16 points uses the DCT-II.
PDPC: when a CU uses the ISP coding mode, the PDPC filters will not be applied to the resulting sub-partitions.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let ty and ty be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w=2 or w>32, t_{H}=DCT-II.
   If h=2 or h>32, t_{V}=DCT-II.
   Otherwise, the transform is selected as in Table 4.

TABLE 4
Transform selection depends on intra mode

| Intra mode | t_{H} | t_{V} |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

In ISP mode, all 67 intra modes are allowed. PDPC is also applied if corresponding width and height is at least 4 samples long. In addition, the condition for intra interpolation filter selection doesn't exist anymore, and Cubic (DCT-IF) filter is always applied for fractional position interpolation in ISP mode.

### 2.1.1.8 Matrix Weighted Intra Prediction (MIP)

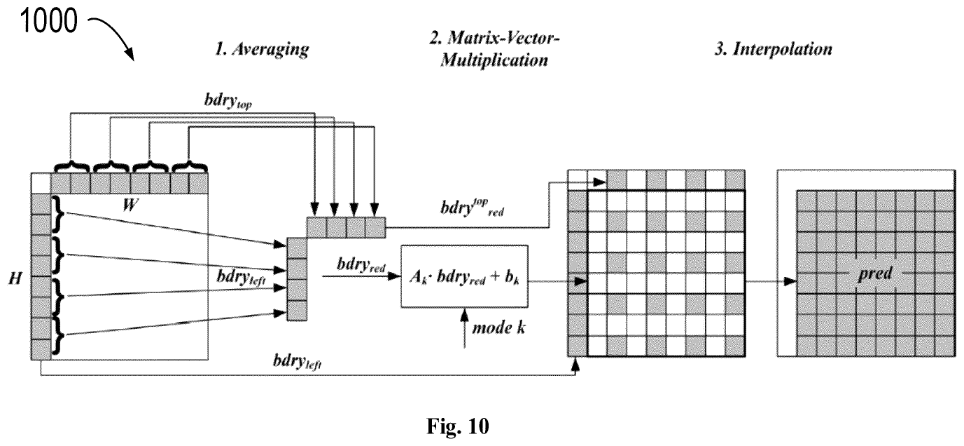

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. FIG. 10 illustrates a schematic diagram 1000 of matrix weighted intra prediction process. The generation of the prediction signal is based on the following three steps, which are averaging, matrix vector multiplication and linear interpolation as shown in FIG. 10.

### Averaging Neighboring Samples

Among the boundary samples, four samples or eight samples are selected by averaging based on block size and shape. Specifically, the input boundaries bdry^{top} and bdry^{left} are reduced to smaller boundaries bdry_{red}^{top} and bdry_{red}^{left} by averaging neighboring boundary samples according to predefined rule depends on block size. Then, the two reduced boundaries bdry_{red}^{top} and bdry_{red}^{left} concatenated to a reduced boundary vector bdry_{red} which is thus of size four for blocks of shape 4×4 and of size eight for blocks of all other shapes. If mode refers to the MIP-mode, this concatenation is defined as follows:

$$\\ \begin{matrix}{bdry}_{red} = \{ \begin{matrix}[ {bdry}_{red}^{{}_{} top} , {bdry}_{red}^{{}_{} left} ] & for W = H = 4 and mode < 18 \\ [ {bdry}_{red}^{{}_{} left} , {bdry}_{red}^{{}_{} top} ] & for W = H = 4 and mode \geq 18 \\ [ {bdry}_{red}^{{}_{} top} , {bdry}_{red}^{{}_{} left} ] & for max ( W , H ) = 8 and mode < 10 \\ [ {bdry}_{red}^{{}_{} left} , {bdry}_{red}^{{}_{} top} ] & for max ( W , H ) = 8 and mode \geq 10 \\ [ {bdry}_{red}^{{}_{} top} , {bdry}_{red}^{{}_{} left} ] & for max ( W , H ) > 8 and mode < 6 \\ [ {bdry}_{red}^{{}_{} left} , {bdry}_{red}^{{}_{} top} ] & for max ( W , H ) > 8 and mode \geq 6.\end{matrix} & ( 2 ‐ 2 )\end{matrix}$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the downsampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 3 )$$

$${H}_{red} = \{ \begin{matrix}4 & for max ( W , H ) \leq 8 \\ min ( H , 8 ) & for max ( W , H ) > 8\end{matrix} \qquad ( 2 - 4 )$$

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8 .\end{matrix} \qquad ( 2 - 5 )$$

Here, each coefficient of the matrix A is represented with 8 bit precision. The set S₀ consists of 16 matrices A₀ⁱ, i∈{0, . . . , 15} each of which has 16 rows and 4 columns and 16 offset vectors b₀ⁱ, i∈{0, . . . , 16} each of size 16. Matrices and offset vectors of that set are used for blocks of size 4×4. The set S₁ consists of 8 matrices A₁ⁱ, i∈{0, . . . , 7}, each of which has 16 rows and 8 columns and 8 offset vectors b₁ⁱ, i∈{0, . . . , 7} each of size 16. The set S₂ consists of 6 matrices A₂ⁱ, i∈{0, . . . , 5}, each of which has 64 rows and 8 columns and of 6 offset vectors b₂ⁱ, i∈{0, . . . , 5} of size 64.

### Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

Signaling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signaled. For an MIP mode, a transposed flag (isTransposed), which determines whether the mode is transposed, and MIP mode Id (modeId), which determines which matrix is to be used for the given MIP mode is derived as follows

$$isTransposed = predModeIntra \& 1 \qquad ( 2 - 6 )$$

$$modeId = predModeIntra >> 1$$

MIP coding mode is harmonized with other coding tools by considering following aspects:
LFNST is enabled for MIP on large blocks. Here, the LFNST transforms of planar mode are used,
The reference sample derivation for MIP is performed exactly as for the conventional intra prediction modes,
For the upsampling step used in the MIP-prediction, original reference samples are used instead of downsampled ones,
Clipping is performed before upsampling and not after upsampling,
MIP is allowed up to 64×64 regardless of the maximum transform size,
The number of MIP modes is 32 for sizeId=0, 16 for sizeId=1 and 12 for sizeId=2.

### 2.1.2 Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction,
Merge mode with MVD (MMVD),
Symmetric MVD (SMVD) signalling,
Affine motion compensated prediction,
Subblock-based temporal motion vector prediction (SbTMVP),
Adaptive motion vector resolution (AMVR),
Motion field storage: 1/16^{th} luma sample MV storage and 8×8 motion field compression,
Bi-prediction with CU-level weight (BCW),
Bi-directional optical flow (BDOF),
Decoder side motion vector refinement (DMVR),
Geometric partitioning mode (GPM),
Combined inter and intra prediction (CIIP).

The following text provides the details on those inter prediction methods specified in VVC.

### 2.1.2.1 Extended Merge Prediction

In VVC, the merge candidate list is constructed by including the following five types of candidates in order:
1) Spatial MVP from spatial neighbour CUs,
2) Temporal MVP from collocated CUs,
3) History-based MVP from an FIFO table,
4) Pairwise average MVP,
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.2.1.1. Spatial Candidates Derivation

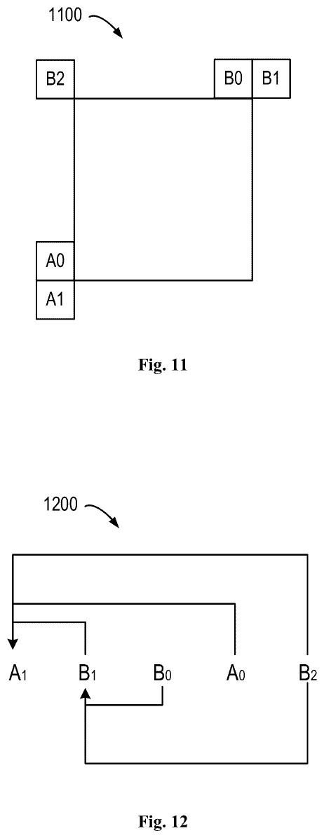

The derivation of spatial merge candidates in VVC is same to that in HEVC except the positions of first two merge candidates are swapped. FIG. 11 illustrates a schematic diagram 1100 of positions of spatial merge candidates. A maximum of four merge candidates are selected among candidates located in the positions depicted in FIG. 11. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 12 illustrates a schematic diagram 1200 of candidate pairs considered for redundancy check of spatial merge candidates. Instead only the pairs linked with an arrow in FIG. 12 are considered and a candidate is only added to the list if the corresponding candidate used for redundancy check has not the same motion information.

### 2.1.2.1.2. Temporal Candidates Derivation

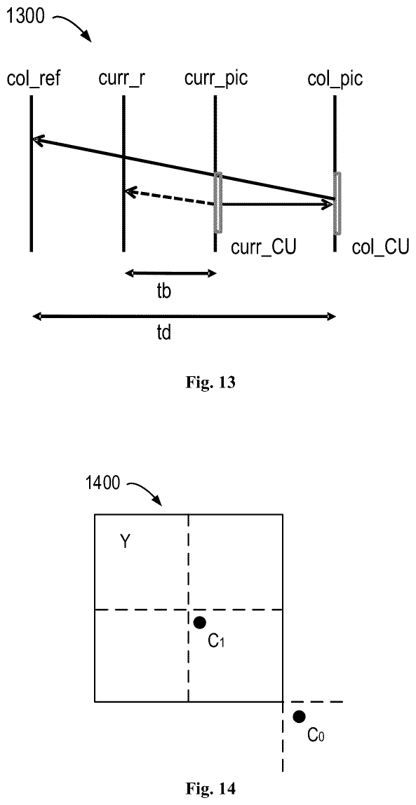

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 13 illustrates a schematic diagram 1300 of motion vector scaling for temporal merge candidate. The scaled motion vector for temporal merge candidate is obtained as illustrated by the dotted line in FIG. 13, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

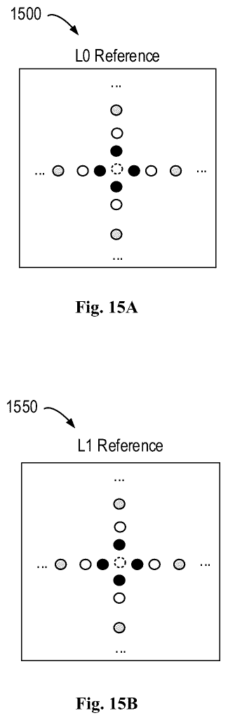

FIG. 14 illustrates a schematic diagram 1400 of candidate positions for temporal merge candidates, C0 and C1. The position for the temporal candidate is selected between candidates C₀ and C₁, as depicted in FIG. 14. If CU at position C₀ is not available, is intra coded, or is outside of the current row of CTUs, position C₁ is used. Otherwise, position C₀ is used in the derivation of the temporal merge candidate.

### 2.1.2.1.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. Number of HMPV candidates is used for merge list generation is set as (N<=4) ? M: (8−N), wherein N indicates number of existing candidates in the merge list and M indicates number of available HMVP candidates in the table.
2. Once the total number of available merge candidates reaches the maximally allowed merge candidates minus 1, the merge candidate list construction process from HMVP is terminated.

### 2.1.2.1.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid. When the merge list is not full after pair-wise average merge candidates are added, the zero MVPs are inserted in the end until the maximum merge candidate number is encountered.

### 2.1.2.2. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

2.1.2.3 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

Distance index specifies motion magnitude information and indicate the pre-defined offset from the starting point. FIG. 15A illustrates a schematic diagram 1500 of MMVD Search Point for L0 reference. FIG. 15B illustrates a schematic diagram 1550 of MMVD Search Point for L1 reference. As shown in FIGS. 15A-15B, an offset is added to either horizontal component or vertical component of starting MV. The relation of distance index and pre-defined offset is specified in Table 5.

TABLE 5
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 6. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 6 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 6 specifies the sign of MV offset added to the list0 MV component of starting MV and the sign for the list1 MV has opposite value.

TABLE 6
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

2.1.2.4. Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{b i - pred} = ( ( 8 - w ) * {P}_{0} + w * {P}_{1} + 4 ) >> 3 \qquad ( 2 - 7 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3, 4, 5}) are used.
At the encoder, fast search algorithms are applied to find the weight index without significantly increasing the encoder complexity. These algorithms are summarized as follows. For further details readers are referred to the VTM software and document. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### 2.1.2.5. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the ATMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j )$$

$$and$$

$$\frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) >> shift1 ) - ( {I}^{( k )} ( i - 1 , j ) >> shift1 ) ) \qquad ( 2 - 8 )$$

$$\frac{\partial {I}^{( k )}}{\partial y} ( i , j ) = ( ( {I}^{( k )} ( i , j + 1 ) >> shift1 ) - ( {I}^{( k )} ( i , j - 1 ) >> shift1 ) )$$

where I^{(k)}(i, j) are the sample value at coordinate (i, j) of the prediction signal in list k, k=0,1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{y} ( i , j ) ) , {S}_{3} = {\sum }_{( i , j ) ∈ Ω} θ ( i , j ) \cdot Sign ( {ψ}_{x} ( i , j ) ) \qquad ( 2 - 9 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \qquad ( 2 - 10 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a}$$

$$θ ( i , j ) = ( {I}^{( 1 )} ( i , j ) >> {n}_{b} ) - ( {I}^{( 0 )} ( i , j ) >> {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

$${v}_{x} = {S}_{1} > 0 ? clip 3 ( - t {h}_{BIO}^{′} , {th}_{BIO}^{′} , - ( ( {S}_{3} \cdot {2}^{{n}_{b} - {n}_{a}} ) >> ⌊ {log}_{2} {S}_{1} ⌋ ) \text{:} 0 \qquad ( 2 - 11 )$$

$${v}_{y} = {S}_{5} > 0 ? clip 3 ( - t {h}_{BIO}^{′} , {th}_{BIO}^{′} , - ( ( {S}_{6} \cdot {2}^{{n}_{b} - {n}_{a}} - ( ( {v}_{x} {S}_{2 , m} ) << {n}_{{S}_{2}} + {v}_{x} {S}_{2 , s} ) / 2 ) >> ⌊ {log}_{2} {S}_{5} ⌋ ) \text{:} 0$$

where S_{2,m}=S₂>n_{S}_{₂}, S_{2,s}=S₂&(2ⁿ^{_{S2}}−1), th′_{BIO}=2^{max(5,BD-7)}. [.] is the floor function, and n_{S}_{₂}=12. Based on the motion refinement and the gradients, the following adjustment is calculated for each sample in the 4×4 subblock:

$$( 2 - 12 )$$

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offse𝔱} ) >> shift \qquad ( 2 - 13 )$$

These values are selected such that the multipliers in the BDOF process do not exceed 15-bit, and the maximum bit-width of the intermediate parameters in the BDOF process is kept within 32-bit.

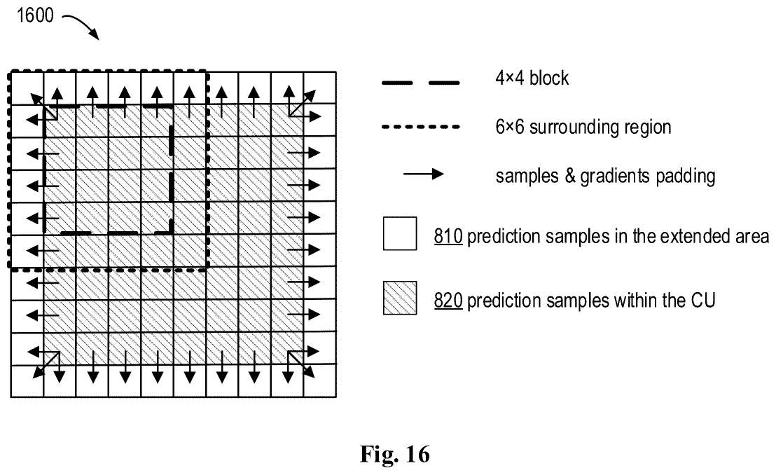

In order to derive the gradient values, some prediction samples I^{(k)}(i, j) in list k (k=0,1) outside of the current CU boundaries need to be generated. FIG. 16 illustrates a schematic diagram 1600 of an extended CU region used in BDOF. As depicted in FIG. 16, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.1.2.6. Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1) At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2) At CU level, a symmetrical mode flag indicating whether symmetrical mode is used or not is explicitly signaled if the CU is bi-prediction coded and BiDirPredFlag is equal to 1.

When the symmetrical mode flag is true, only mvp_l0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 14 )$$

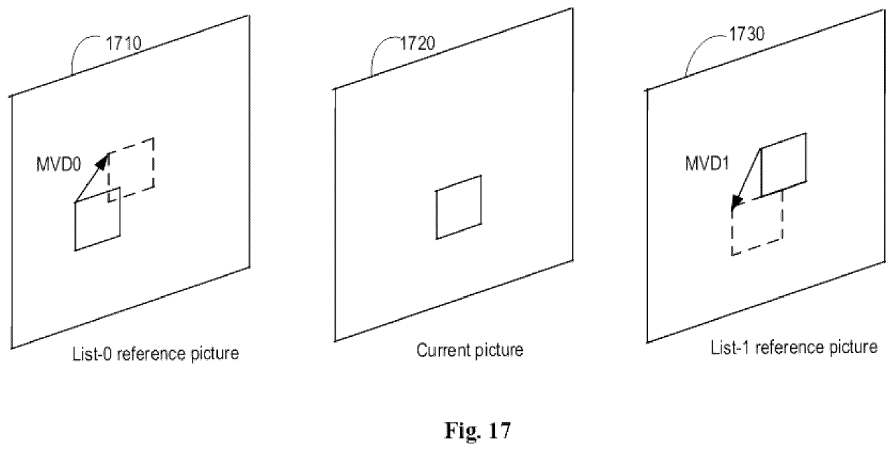

FIG. 17 illustrates a schematic diagram of an illustration for symmetrical MVD mode. In the encoder, symmetric MVD motion estimation starts with initial MV evaluation. A set of initial MV candidates comprising of the MV obtained from uni-prediction search, the MV obtained from bi-prediction search and the MVs from the AMVP list. For example, there are a List-0 reference picture 1710 and a List-1 reference picture 1730 for the current picture 1720. The one with the lowest rate-distortion cost is chosen to be the initial MV for the symmetric MVD motion search.

### 2.1.2.7. Decoder Side Motion Vector Refinement (DMVR)

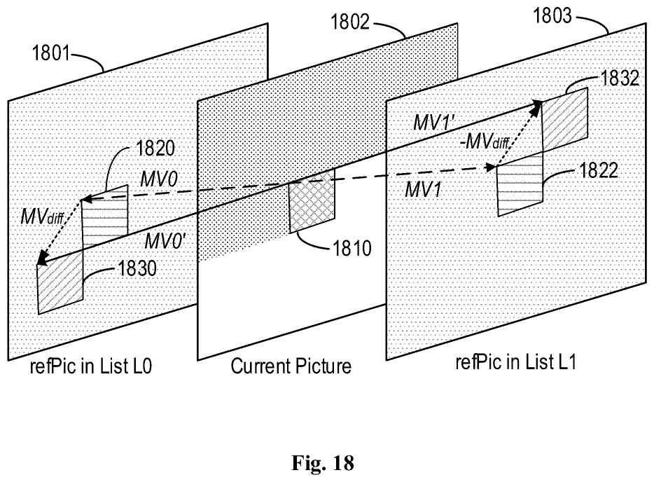

In order to increase the accuracy of the MVs of the merge mode, a bilateral-matching based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 18 illustrates a decoding side motion vector refinement. As illustrated in FIG. 18, the SAD between the blocks 1810 and 1812 based on each MV candidate around the initial MV is calculated, where the block 1810 is in a reference picture 1801 in the list L0 and the block 1812 is in a reference picture 1803 in the List L1 for the current picture 1802. The MV candidate with the lowest SAD becomes the refined MV and used to generate the bi-predicted signal.

In VVC, the DMVR can be applied for the CUs which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.2.7.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 2 - 15 )$$

$$MV {1}^{′} = MV 1 - MV\_offset \qquad ( 2 - 16 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C \qquad ( 2 - 17 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 - 18 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 2 - 19 )$$

The value of xₘᵢₙ and yₘᵢₙ are automatically constrained to be between−8 and 8 since all cost values are positive and the smallest value is E(0,0). This corresponds to half peal offset with 1/16th-pel MV accuracy in VVC. The computed fractional (xₘᵢₙ) yₘᵢₙ) are added to the integer distance refinement MV to get the sub-pixel accurate refinement delta MV.

### 2.1.2.7.2. Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.2.7.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.2.8. Combined Inter and Intra Prediction (CIIP)

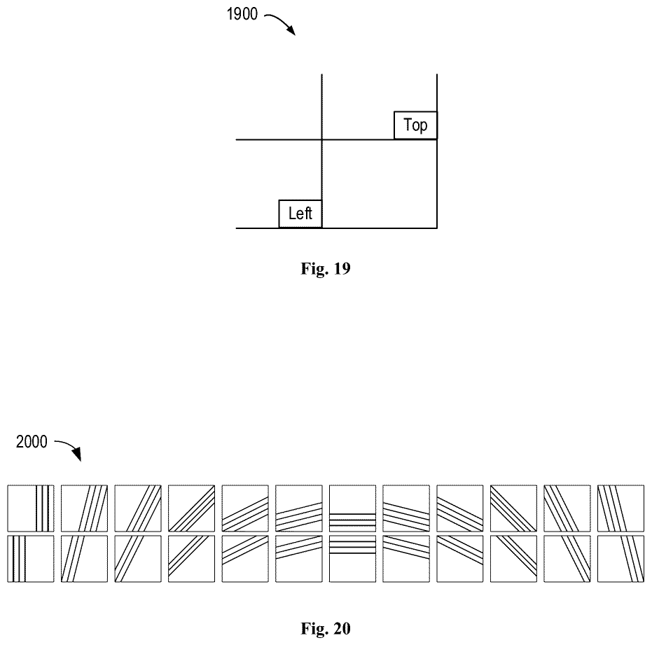

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. FIG. 19 illustrates a schematic diagram 1900 of top and left neighboring blocks used in CIIP weight derivation. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value is calculated depending on the coding modes of the top and left neighbouring blocks (depicted in FIG. 19) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{inter} + w t * {P}_{intra} + 2 ) ≫ 2 \qquad \text{(2-20)}$$

### 2.1.2.9. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

FIG. 20 illustrates a schematic diagram 2000 of examples of the GPM splits grouped by identical angles. When this mode is used, a CU is split into two parts by a geometrically located straight line (as shown in FIG. 20). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### 2.1.2.9.1. Uni-Prediction Candidate List Construction

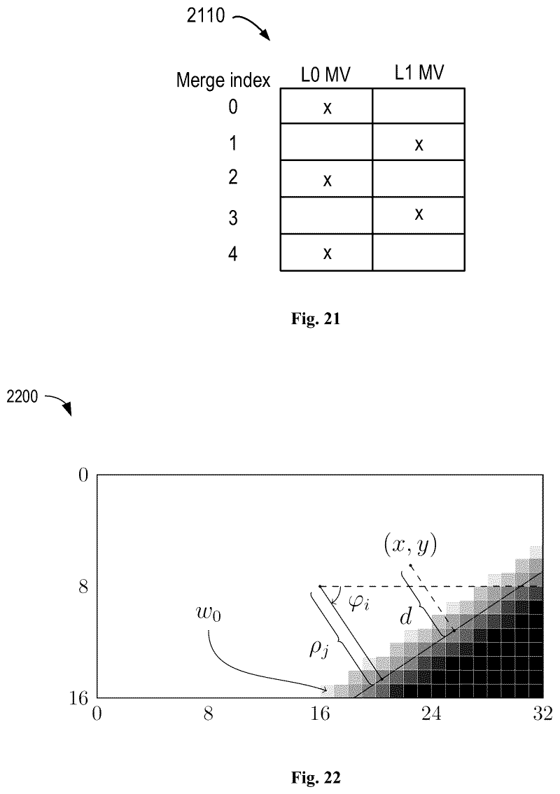

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. FIG. 21 illustrates a schematic diagram 2100 of uni-prediction MV selection for geometric partitioning mode. These motion vectors are marked with “x” in FIG. 21. In case a corresponding LX motion vector of the n-the extended merge candidate does not exist, the L(1−X) motion vector of the same candidate is used instead as the uni-prediction motion vector for geometric partitioning mode.

### 2.1.2.9.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 21 )$$

$${ρ}_{j} = {ρ}_{x , j} cos ( {φ}_{i} ) + {ρ}_{y , j} sin ( {φ}_{i} ) \qquad ( 2 - 22 )$$

$$\begin{matrix}{ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} & ( 2 - 23 )\end{matrix}$$

$${ρ}_{y , j} = \{ \begin{matrix}\pm ( j \times w ) ≫ 2 & i \% 16 = 8 or ( i \% 16 \neq 0 and h \geq w ) \\ 0 & otherwise\end{matrix} \qquad ( 2 - 24 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad \text{(2-25)}$$

$${w}_{0} ( x , y ) = \frac{Clip 3 ( 0 , 8 , ( wIdxL ( x , y ) + 4 ) ≫ 3 )}{8} \qquad ( 2 - 26 )$$

$${w}_{1} ( x , y ) = 1 - {w}_{0} ( x , y ) \qquad ( 2 - 27 )$$

The partIdx depends on the angle index i. FIG. 22 illustrates a schematic diagram 2200 of exemplified generation of a bending weight wo using geometric partitioning mode.

### 2.1.2.9.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 43 )$$

where motionIdx is equal to d(4×+2,4y+2), which is recalculated from equation (2-36). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   2.1.2.9.4. GPM with Inter and Intra Prediction (GPM Inter-Intra)

With the GPM inter-intra, pre-defined intra prediction modes against geometric partitioning line can be selected in addition to merge candidates for each non-rectangular split region in the GPM-applied CU. In the proposed method, whether intra or inter prediction mode is determined for each GPM-separated region with a flag from the encoder. When the inter prediction mode, a uni-prediction signal is generated by MVs from the merge candidate list. On the other hand, when the intra prediction mode, a uni-prediction signal is generated from the neighboring pixels for the intra prediction mode specified by an index from the encoder. The variation of the possible intra prediction modes is restricted by the geometric shapes. Finally, the two uni-prediction signals are blended with the same way of ordinary GPM.

### 2.1.2.10. Multi-Hypothesis Prediction (MHP)

The multi-hypothesis prediction is adopted in this contribution. Up to two additional predictors are signalled on top of inter AMVP mode, regular merge mode, and MMVD mode. The resulting overall prediction signal is accumulated iteratively with each additional prediction signal.

$${P}_{n + 1} = ( 1 - {α}_{n + 1} ) {p}_{n} + {α}_{n + 1} {h}_{n + 1}$$

The weighting factor α is specified according to the following table:

| add_hyp_weight_idx | α |
|---|---|
| 0 | ¼ |
| 1 | −⅛ |

For inter AMVP mode, MHP is only applied if non-equal weight in BCW is selected in bi-prediction mode.

### 2.1.2.11. OBMC

This contribution uses complexity reduction methods for overlapped block motion compensation (OBMC). To reduce computational complexity, lossless data reuse, coding unit (CU) boundary only OBMC, removal of OBMC syntax, and disabling OBMC for small and large CUs are proposed. To remove all the additional motion compensation (MC) bandwidth, replacing additional reference samples required by the JEM OBMC with padded reference samples is proposed. To save the line buffer requirement, decreasing the number of blended lines from 4 to 2 at CTU row boundaries is proposed. To allow parallel processing for top and left boundaries of a CU, a parallel blending method is proposed.

When OBMC is applied, top and left boundary pixels of a CU are refined using neighboring block's motion information with a weighted prediction.

Conditions of not applying OBMC are as follows:
When OBMC is disabled at SPS level.
When current block has intra mode or IBC mode.
When current block applies LIC.
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

Seven aspects of OBMC are proposed. To reduce computational complexity, lossless data reuse, CU boundary only OBMC, removal of OBMC syntax, and disabling small and large CUs for OBMC are proposed and presented in sections 2.1.2.11.1, 2.1.2.11.2, 2.1.2.11.3 and 2.1.2.11.4, respectively. To remove all the additional MC bandwidth, replacing additional reference samples with padded reference samples is proposed and presented in section 2.1.2.11.5. To save the line buffer requirement, decreasing the number of blended lines at CTU row boundaries is proposed and presented in section 2.1.2.11.6. To allow parallel processing for top and left boundaries of a CU, parallel blending is proposed and presented in section 2.1.2.11.7.

### 2.1.2.11.1. Lossless Data Reuse

Redundant MC operations in JEM OBMC are removed. Two data reuse methods are proposed and described. The first method (L-buffer OBMC block reuse) can reduce encoding time and does not change encoder outputs. The second method (MC merging) can reduce both encoding time and decoding time and does not change encoder and decoder outputs.

At encoder, one L-buffer can be used to store OBMC blocks of the first row and first column blocks in the current CU at top and left CU boundaries. The OBMC blocks stored in the L-buffer can be shared for different rate-distortion optimization (RDO) processes of CU mode candidates. The L-buffer has a top part to store top block boundary OBMC blocks (top-direction OBMC of top 4×4 row) and a left part to store left block boundary OBMC blocks (left-direction OBMC of left 4×4 column). In our implementation, in the current CU, for each 4×4 block at the first row/column, when this 4×4 block needs top/left block boundary OBMC block for the first time, it will do actual 4×4 block MC to obtain the OBMC block and store it into this 4×4 block buffer. For any other RDO processes of different CU mode candidates, no 4×4 block MC will be executed, and the stored OBMC block can be reused. Readers can refer to JVET-K0258 for better understanding.

When generating top/left block boundary OBMC blocks at the top/left CU boundaries, if adjacent OBMC blocks have the same motion information (reference index and motion vector), they can be generated together to save encoding time and decoding time. That is, the MC operations of adjacent OBMC blocks of the same motion information can be merged into one MC operation of a larger OBMC block for saving redundant memory access. Readers can refer to JVET-K0258 for better understanding.

### 2.1.2.11.2. CU Boundary Only OBMC

OBMC will only be applied at top and left CU boundaries of a current CU.

### 2.1.2.11.3. Removal of OBMC Syntax

The CU-level OBMC flag is removed. In this way, the encoder does not need OBMC on/off decision, and the decoder does not need to parse the OBMC flag. OBMC is always turned on for inter CUs if not specified otherwise.

### 2.1.2.11.4. Disabling OBMC for Small and Large CUs

OBMC is disabled for CUs with sizes smaller than 64 luma samples or larger than 1024 luma samples.

2.1.2.11.5. Replacing Additional Reference Samples with Padded Reference Samples

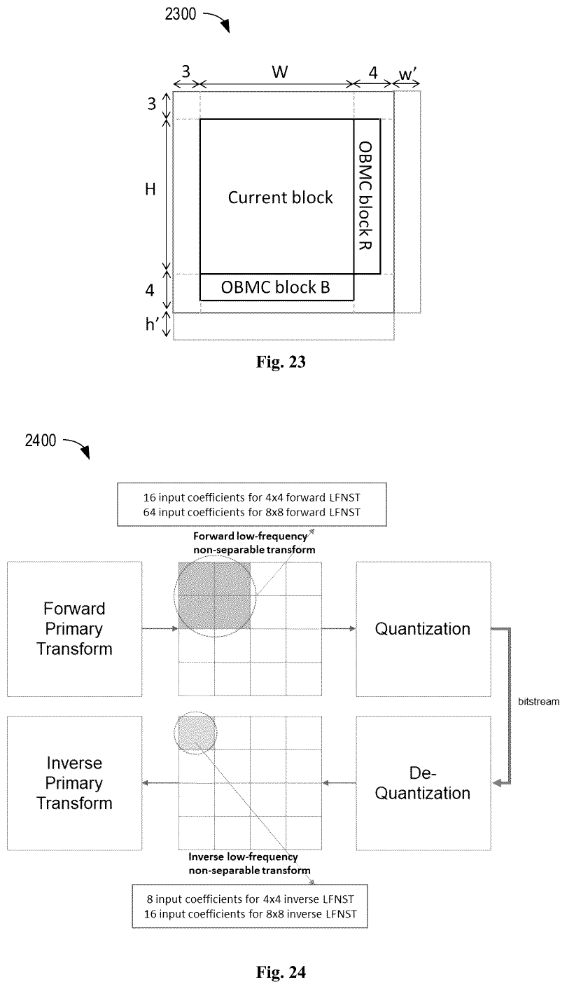

FIG. 23 illustrates a diagram 2300 showing reference samples with padding for OBMC. It is proposed to pad (3+W+4)*(3+H+4) reference samples to (3+W+4+w′)*(3+H+4+h′), where w′ and h′ are the width and height of OBMC region respectively, as shown in FIG. 23. The w′ columns in orange region, which are the additional samples required to derive OBMC block R, are generated by replicating the samples in the right-most column of the blue region. The h′ rows in green region, which are the additional samples required to derive OBMC block B, are generated by replicating the samples in the bottom row of the blue region. Readers can refer to JVET-K0259 for better understanding.

### 2.1.2.11.6. Decreasing the Number of Blended Lines at CTU Row Boundaries

To reduce the line buffer size, if the current block is at a CTU row boundary, then the number of blended lines for OBMC is reduced from 4 to 2.

### 2.1.2.11.7. Parallel Blending

The proposed parallel blending can be applied to CU boundary only OBMC and sub-block OBMC. The idea is shown in equations as follows:

$$F ( x , y ) = ( L ( x , y ) * w ( x ) + R ( x , y ) * w ( width - 1 - x ) + T ( x , y ) * w ( y ) + B ( x , y ) * w ( height - 1 - y ) + C ( x , y ) * rem\_w ( x , y ) + 16 ) >> 5$$

For Luma case:
w(i)=8 4 2 1 (normal blending) or $4 0 0 (simplified blending)
(i=0˜3)
e.g. w(1)=4
e.g. w(0)=8

For Chroma case:
w(i)=8 4 (normal blending) or 8 0 (simplified blending)
(i=0˜1)
   where the F(x,y) is the final blending result, the C(x,y) is the current 4×4 block predictor, and the L(x,y)/R(x,y)/T(x,y)/B(x,y) is the left/right/top/bottom block OBMC block. If the left/right/top/bottom block boundary OBMC is skipped (when (1) unavailable boundary or (2) same motion as current sub-block or (3) internal boundaries when CU boundary only OBMC is applied), the L(x,y)/R(x,y)/T(x,y)/B(x,y) is replaced with C(x,y). The width/height is the current sub-block width/height, e.g, in luma, the width/height is 4. The w(i) is a weight table. The rem_w(x,y) is the “remaining weight” defined as (32−w(x)−w(width-x)−w(y)−w(height-y)). For fixed width, height, and blending type (normal blending or simplified blending), the rem_w(x,y) is fixed for any sub-block and can be easily implemented by table look-up. Readers can refer to JVET-K0258 for better understanding.

### 2.1.3. Transform and Quantization

2.1.3.1. Large Block-Size Transforms with High-Frequency Zeroing

In VVC, large block-size transforms, up to 64×64 in size, are enabled, which is primarily useful for higher resolution video, e.g., 1080p and 4K sequences. High frequency transform coefficients are zeroed out for the transform blocks with size (width or height, or both width and height) equal to 64, so that only the lower-frequency coefficients are retained. For example, for an M×N transform block, with M as the block width and N as the block height, when M is equal to 64, only the left 32 columns of transform coefficients are kept. Similarly, when N is equal to 64, only the top 32 rows of transform coefficients are kept. When transform skip mode is used for a large block, the entire block is used without zeroing out any values. In addition, transform shift is removed in transform skip mode. The VTM also supports configurable max transform size in SPS, such that encoder has the flexibility to choose up to 32-length or 64-length transform size depending on the need of specific implementation.

### 2.1.3.2 Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 7 shows the basis functions of the selected DST/DCT.

TABLE 7
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 8. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 8
Transform and signalling mapping table

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.1.3.3. Low-Frequency Non-Separable Transform (LFNST)

FIG. 24 illustrates a schematic diagram 2400 of a low-frequency non-separable transform (LFNST) process. In VVC, LFNST is applied between forward primary transform and quantization (at encoder) and between de-quantization and inverse primary transform (at decoder side) as shown in FIG. 24. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad ( 2 - 29 )$$

is first represented as a vector [symbol] :

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T} \qquad ( 2 - 30 )$$

The non-separable transform is calculated as [symbol] =T· [symbol] , where [symbol] indicates the transform coefficient vector, and Tis a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### 2.1.3.3.1. Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${{T}_{RxN}}_{{=}^{}} [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {r}_{31} & {t}_{32} & {t}_{33} & … & {t}_{3 N}\end{matrix} ] \qquad ( 2 - 31 )$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### 2.1.3.3.2. LFNST Transform Selection

There are totally 4 transform sets and 2 non-separable transform matrices (kernels) per transform set are used in LFNST. The mapping from the intra prediction mode to the transform set is pre-defined as shown in Table 9. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 9
Transform selection table

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

2.1.3.3.3. LFNST Index Signaling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### 2.1.3.4. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

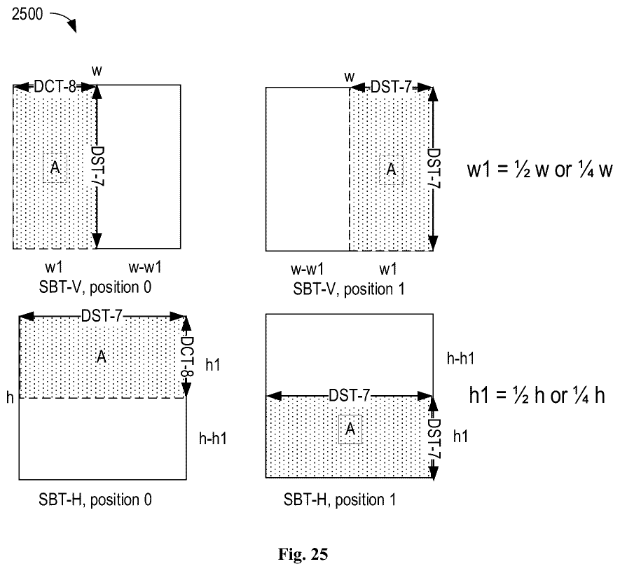

When SBT is used for an inter-coded CU, SBT type and SBT position information are signaled in the bitstream. FIG. 25 illustrates a schematic diagram 2500 of examples of SBT position, type and transform type. There are two SBT types and two SBT positions, as indicated in FIG. 25. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 25. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 2.1.3.5. Maximum Transform Size and Zeroing-Out of Transform Coefficients

Both CTU size and maximum transform size (i.e., all MTS transform kernels) are extended to 256, where the maximum intra coded block can have a size of 128×128. The maximum CTU size is set to 256 for UHD sequences and it is set to 128, otherwise. In the primary transformation process, there is no normative zeroing out operation applied on transform coefficients. However, if LFNST is applied, the primary transform coefficients outside the LFNST region are normatively zeroed-out.

### 2.1.3.6. Enhanced MTS for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 4 different transform pairs are considered, the same as that of VVC. Note, although a total of 80 different classes are considered, some of those different classes often share exactly same transform set. So there are 58 (less than 80) unique entries in the resultant LUT. For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between−2 and −14. Similarly, mode 66 is used for mode 67 to mode 80.

MTS index [0,3] is signalled with 2 bit fixed-length coding.

2.1.3.7. Secondary Transformation: LFNST Extension with Large Kernel

The LFNST design in VVC is extended as follows:
The number of LFNST sets (S) and candidates (C) are extended to S=35 and C=3, and the LFNST set (IfnstTrSetIdx) for a given intra mode (predModeIntra) is derived according to the following formula:
   For predModeIntra<2, IfnstTrSetIdx is equal to 2,
   lfnstTrSetIdx=predModeIntra, for predModeIntra in [0,34],
   IfnstTrSetIdx=68−predModeIntra, for predModeIntra in [35,66].
Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The kernel dimensions are specified by:

$$( LFSNT 4 , LFNST {8}^{*} , LFNST {16}^{*} = ( 16 \times 16 , 32 \times 64 , 32 \times 96 )$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

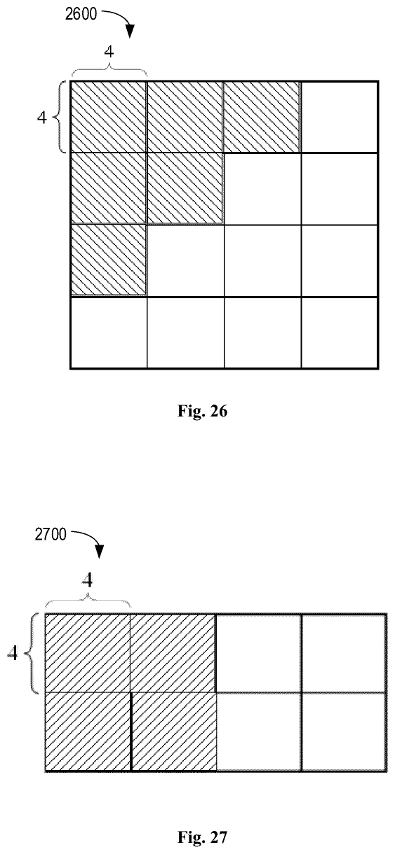

FIG. 26 illustrates a schematic diagram 2600 of examples of the ROI for LFNST16. The ROI for LFNST16 is depicted in FIG. 26. It consists of six 4×4 sub-blocks, which are consecutive in scan order. Since the number of input samples is 96, transform matrix for forward LFNST16 can be Rx96. R is chosen to be 32 in this contribution, 32 coefficients (two 4×4 sub-blocks) are generated from forward LFNST16 accordingly, which are placed following coefficient scan order.

FIG. 27 illustrates a schematic diagram 2700 of examples of the ROI for LFNST8. The ROI for LFNST8 is shown in FIG. 27. The forward LFNST8 matrix can be Rx64 and R is chosen to be 32. The generated coefficients are located in the same manner as with LFNST16.

The mapping from intra prediction modes to these sets is shown in Table 10,

TABLE 10
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |
| Intra pred. mode | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| Intra pred. mode | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| Intra pred. mode | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 3 | 2 |

### 2.1.3.8. Sign Prediction

The basic idea of the coefficient sign prediction method is to calculate reconstructed residual for both negative and positive sign combinations for applicable transform coefficients and select the hypothesis that minimizes a cost function.

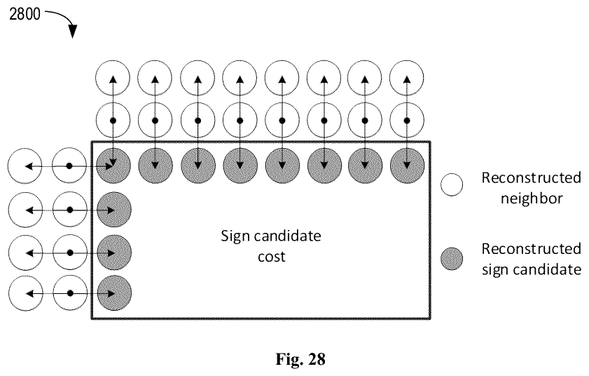

FIG. 28 illustrates a schematic diagram 2800 of a discontinuity measure. To derive the best sign, the cost function is defined as discontinuity measure across block boundary shown on FIG. 28. It is measured for all hypotheses, and the one with the smallest cost is selected as a predictor for coefficient signs.

The cost function is defined as a sum of absolute second derivatives in the residual domain for the above row and left column as follows:

$$cost = {\sum }_{x = o}^{w} \vert x = o ( - {R}_{x , - 1} + 2 {R}_{x , 0} - {P}_{x , 1} ) - {r}_{x , 1} \vert + {\sum }_{y = o}^{h} \vert ( - {R}_{- 1 , y} + 2 {R}_{0 , y} - {P}_{1 , y} ) - {r}_{1 , y} \vert$$

where R is reconstructed neighbors, P is prediction of the current block, and r is the residual hypothesis. The term (−R₋₁+2 R₀−P₁) can be calculated only once per block and only residual hypothesis is subtracted.
2.1.4. Luma Mapping with Chroma Scaling (LMCS)

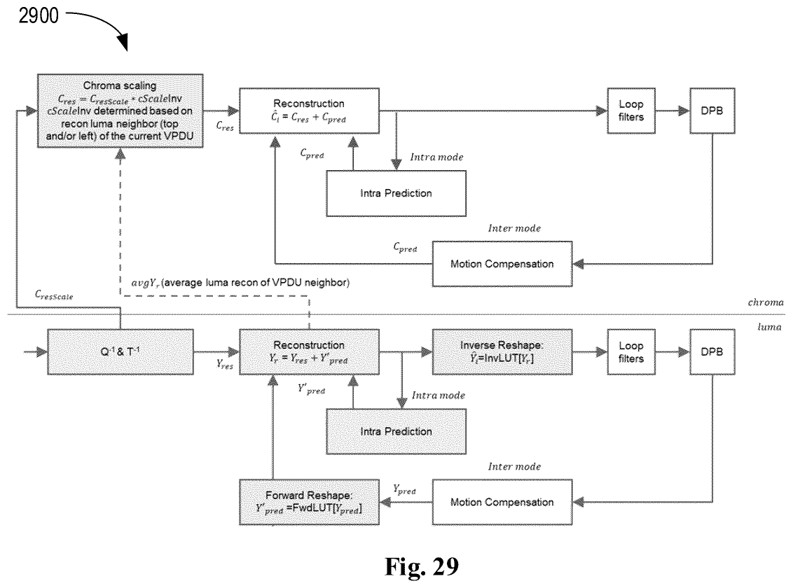

FIG. 29 illustrates a schematic diagram 2900 of luma mapping with chroma scaling architecture. In VVC, a coding tool called the luma mapping with chroma scaling (LMCS) is added as a new processing block before the loop filters. LMCS has two main components: 1) in-loop mapping of the luma component based on adaptive piecewise linear models; 2) for the chroma components, luma-dependent chroma residual scaling is applied. FIG. 29 shows the LMCS architecture from decoder's perspective. The light-blue shaded blocks in FIG. 29 indicate where the processing is applied in the mapped domain; and these include the inverse quantization, inverse transform, luma intra prediction and adding of the luma prediction together with the luma residual. The unshaded blocks in FIG. 29 indicate where the processing is applied in the original (i.e., non-mapped) domain; and these include loop filters such as deblocking, ALF, and SAO, motion compensated prediction, chroma intra prediction, adding of the chroma prediction together with the chroma residual, and storage of decoded pictures as reference pictures. The light-yellow shaded blocks in FIG. 29 are the new LMCS functional blocks, including forward and inverse mapping of the luma signal and a luma-dependent chroma scaling process. Like most other tools in VVC, LMCS can be enabled/disabled at the sequence level using an SPS flag.

2.1.4.1. Luma Mapping with Piecewise Linear Model

The in-loop mapping of the luma component adjusts the dynamic range of the input signal by redistributing the codewords across the dynamic range to improve compression efficiency. Luma mapping makes use of a forward mapping function, FwdMap, and a corresponding inverse mapping function, InvMap. The FwdMap function is signalled using a piecewise linear model with 16 equal pieces. InvMap function does not need to be signalled and is instead derived from the FwdMap function.

The luma mapping model is signalled in the adaptation parameter set (APS) syntax structure with aps_params_type set equal to 1 (LMCS_APS). Up to 4 LMCS APS's can be used in a coded video sequence. Only 1 LMCS APS can be used for a picture. The luma mapping model is signalled using piecewise linear model. The piecewise linear model partitions the input signal's dynamic range into 16 equal pieces, and for each piece, its linear mapping parameters are expressed using the number of codewords assigned to that piece. Take 10-bit input as an example. Each of the 16 pieces will have 64 codewords assigned to it by default. The signalled number of codewords is used to calculate the scaling factor and adjust the mapping function accordingly for that piece. At the slice level, an LMCS enable flag is signalled to indicate if the LMCS process as depicted in FIG. 29 is applied to the current slice. If LMCS is enabled for the current slice, an aps_id is signalled in the slice header to identify the APS that carries the luma mapping parameters.

Each i-th piece, i=0 . . . 15, of the FwdMap piecewise linear model is defined by two input pivot points InputPivot[ ] and two output (mapped) pivot points MappedPivot[ ].

The InputPivot[ ] and MappedPivot[ ] are computed as follows (assuming 10-bit video):
1) OrgCW=64
2) For i=0:16, InputPivot[i]=i*OrgCW
3) For i=0:16, MappedPivot[i] is calculated as follows:
Mapped Pivot[0]=0; for(i=0; i<16; i++)
   Mapped Pivot[i+1]=MappedPivot[i]+SignalledCW[i]
      where SignalledCW[i] is the signalled number of codewords for the i-th piece.

As shown in FIG. 29, for an inter-coded block, motion compensated prediction is performed in the mapped domain. In other words, after the motion-compensated prediction block Y_{pred} is calculated based on the reference signals in the DPB, the FwdMap function is applied to map the luma prediction block in the original domain to the mapped domain, Y′_{pred}=FwdMap(Y_{pred}). For an intra-coded block, the FwdMap function is not applied because intra prediction is performed in the mapped domain. After reconstructed block Yᵣ is calculated, the InvMap function is applied to convert the reconstructed luma values in the mapped domain back to the reconstructed luma values in the original domain (Ŷᵢ=InvMap(Yᵣ)). The InvMap function is applied to both intra- and inter-coded luma blocks.

The luma mapping process (forward and/or inverse mapping) can be implemented using either look-up-tables (LUT) or using on-the-fly computation. If LUT is used, then FwdMapLUT and InvMapLUT can be pre-calculated and pre-stored for use at the tile group level, and forward and inverse mapping can be simply implemented as FwdMap(Y_{pred})=FwdMapLUT[Y_{pred}] and InvMap(Yᵣ)=InvMapLUT [Yᵣ], respectively. Alternatively, on-the-fly computation may be used. Take forward mapping function FwdMap as an example. In order to figure out the piece to which a luma sample belongs, the sample value is right shifted by 6 bits (which corresponds to 16 equal pieces). Then, the linear model parameters for that piece are retrieved and applied on-the-fly to compute the mapped luma value. Let i be the piece index, a1, a2 be InputPivot[i] and InputPivot[i+1], respectively, and b1, b2 be MappedPivot[i] and MappedPivot[i+1], respectively. The FwdMap function is evaluated as follows:

$$FwdMap ( {Y}_{pred} ) = ( ( b 2 - b 1 ) / ( a 2 - a 1 ) ) * ( {Y}_{pred} - a 1 ) + b 1$$

The InvMap function can be computed on-the-fly in a similar manner. Generally, the pieces in the mapped domain are not equal sized, therefore the most straightforward inverse mapping process would require comparisons in order to figure out to which piece the current sample value belongs. Such comparisons increase decoder complexity. For this reason, VVC imposes a bistream constraint on the values of the output pivot points MappedPivot[i] as follows. Assume the range of the mapped domain (for 10-bit video, this range is [0, 1023]) is divided into 32 equal pieces. If MappedPivot[i] is not a multiple of 32, then MappedPivot[i+1] and MappedPivot[i] cannot belong to the same piece of the 32 equal-sized pieces, i.e. MappedPivot[i+1]>>(BitDepth_{Y}−5) shall not be equal to MappedPivot[i]>>(BitDepth_{Y}−5). Thanks to such bitstream constraint, the InvMap function can also be carried out using a simple right bit-shift by 5 bits (which corresponds 32 equal-sized pieces) in order to figure out the piece to which the sample value belongs.

### 2.1.4.2. Luma-Dependent Chroma Residual Scaling

Chroma residual scaling is designed to compensate for the interaction between the luma signal and its corresponding chroma signals. Whether chroma residual scaling is enabled or not is also signalled at the slice level. If luma mapping is enabled, an additional flag is signalled to indicate if luma-dependent chroma residual scaling is enabled or not. When luma mapping is not used, luma-dependent chroma residual scaling is disabled. Further, luma-dependent chroma residual scaling is always disabled for the chroma blocks whose area is less than or equal to 4.

Chroma residual scaling depends on the average value of top and/or left reconstructed neighbouring luma samples of the current VPDU. If the current CU is inter 128×128, inter 128×64 and inter 64×128, then the chroma residual scaling factor derived for the CU associated with the first VPDU is used for all chroma transform blocks in that CU. Denote avgYr as the average of the reconstructed neighbouring luma samples (see FIG. 29). The value of C_{ScaleInv} is computed in the following steps:
1) Find the index Y_{Idx} of the piecewise linear model to which avgYr belongs based on the InvMap function.
2) C_{ScaleInv}=cScaleInv[Y_{Idx}], where cScaleInv[ ] is a 16-piece LUT pre-computed based on the value of SignalledCW[i] and a offset value signalled in APS for chroma residual scaling process.

Unlike luma mapping, which is performed on the sample basis, C_{ScaleInv} is a constant value for the entire chroma block. With C_{ScaleInv}, chroma residual scaling is applied as follows:

$$Encoder side : {C}_{ResScale} = {C}_{Res} * {C}_{Scale} = {C}_{Res} / {C}_{ScaleInv}$$

$$Decoder side : {C}_{Res} = {C}_{ResScale} / {C}_{Scale} = {C}_{Res Scale} * {C}_{ScaleInv}$$

### 3. PROBLEMS

There are several issues in the existing video coding techniques, which would be further improved for higher coding gain.
1. Generally, the OBMC blends multiple inter predictions in the original domain, while the intra prediction is performed at LMCS reshaped domain. When GPM inter-intra is applied, how to apply OBMC on top of the GPM inter-intra prediction need to be considered.
2. Template matching based method usually compares samples between two templates through one cost function (such as SAD/SATD of samples within the template which is constructed just from neighboring samples). when more one template matching scheme is allowed in the codec, how to use this technique need to be considered.
3. Multiple reference line/column may be applied to different coding tools, with rules/constraints performed.
4. Intra mode candidate may be generated from previously historical candidate list/table.
5. Partition information may be derived based on a history table with partition status of previous coded blocks.

### 4. DETAILED DESCRIPTION

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., AMVP, Merge, SMVD, BDOF, PROF, DMVR, AMVR, TM, Affine, CIIP, GPM, GEO, TPM, MMVD, BCW, HMVP, SbTMVP, and etc.).

It is noted that the terminologies mentioned below are not limited to the specific ones defined in existing standards. Any variance of the coding tool is also applicable.

### Consistency Between GPM Inter-Intra, OBMC, and LMCS

1. For example, OBMC may be firstly performed on the inter prediction in the original domain, then a forward mapping is applied, and the outcome may be further processed by a procedure.
   a. For example, the inter-prediction may be GPM inter prediction.
   b. For example, the inter-prediction may be the inter prediction of a GPM variant mode.
   c. For example, the further procedure may be to weight with GPM intra prediction in the reshaped domain.
   d. For example, firstly, OBMC may be applied to the GPM inter prediction in the original domain, to get an original domain OBMC compensated GPM inter prediction. Then, a forward LMCS mapping is applied to the original domain OBMC compensated prediction to get a reshaped domain OBMC compensated GPM inter prediction. After that, the reshaped domain GPM intra prediction is further weighted blended with the reshaped OBMC compensated prediction, to get the final OBMC compensated GPM inter-intra blended prediction in the reshaped domain.
2. For example, a first inter prediction may be firstly forward mapped to reshaped domain, then it may be processed by a procedure to get a second prediction. Forward mapping may be applied to other inter predictions participating in the OBMC process. In this way, the OBMC is finally performed in the reshaped domain.
   a. For example, the first inter prediction may be GPM inter prediction.
   b. For example, the first inter-prediction may be the inter prediction of a GPM variant mode.
   c. The procedure may be to weight blended with GPM intra prediction.
   d. For example, firstly, a forward LMCS mapping may be applied to the GPM inter prediction, to get a reshaped domain GPM inter prediction. Secondly, the reshaped domain GPM inter prediction is further weighted blended with the reshaped domain GPM intra prediction to get a reshaped domain GPM blended prediction. Thirdly, forward LMCS mapping is applied to the other inter predictions which used in OBMC process. Lastly, OBMC is applied in the reshaped domain to blend the reshaped domain GPM inter-intra prediction and other reshaped domain inter predictions.
3. For example, GPM intra prediction is firstly inverse mapped to original domain, then weighted blend with GPM inter prediction in the original domain. After that, OBMC is performed in the original domain. Finally, a forward mapping is applied to the OBMC compensated prediction.
   a. For example, firstly, an inverse LMCS mapping may be applied to the GPM intra prediction, to get an original domain GPM intra prediction. Secondly, the original domain GPM intra prediction is further weighted blended with the original domain GPM inter prediction to get an original domain GPM blended prediction. Thirdly, OBMC is applied to the original domain GPM blended prediction, to get an original domain OBMC compensated prediction. Finally, a forward LMCS mapping is applied to get a reshaped domain OBMC compensated GPM inter-intra prediction.

### Template Matching Based

4. For example, more than one template matching method may be allowed to be used for a video unit.
   a. For example, the video unit may be coded by an intra prediction methods as follows:
      i. TIMD and/or its variants,
      ii. DIMD and/or its variants,
      iii. MPM candidates sorting.
   b. For example, the video unit may be coded by one or multiple inter prediction methods as follows (the multiple inter prediction methods may be applied orderly):
      i. GPM and/or its variants, e.g., GPM-TM,
      ii. CIIP and/or its variants, e.g., CIIP-TM,
      iii. Regular merge and/or its variants, e.g., TM-merge,
      iv. AMVP and/or its variants, e.g., TM-amvp,
      v. MMVD and/or its variants, e.g., TM-MMVD,
      vi. Affine and/or its variants, e.g., TM-affine.
   c. For example, motion candidates reordering method (such as ARMC) may be based on more than one type of template matching scheme.
      i. For example, more than one type of template matching scheme may be used to reorder regular merge candidates.
      ii. For example, more than one type of template matching scheme may be used to reorder CIIP merge candidates.
      iii. For example, more than one type of template matching scheme may be used to reorder GPM merge candidates.
      iv. For example, more than one type of template matching scheme may be used to reorder MMVD merge candidates.
      v. For example, more than one type of template matching scheme may be used to reorder AMVP candidates.
      vi. For example, more than one type of template matching scheme may be used to reorder Affine (affine merge, and/or affine amvp) candidates.
      vii. Furthermore, alternatively, different numbers of motion candidates may be allowed depending on the template matching scheme and/or prediction methods.
   d. For example, the multiple template matching methods may be based on different cost function, i.e., one template matching uses cost function A, another template matching uses cost function B.
      i. For example, a cost function may be based on a discontinuity measure across block boundary.
      ii. For example, a cost function may be based on a sum of absolute second derivatives in the residual domain for the above row and left column, an example is illustrated as follows:

$$cost = {\sum }_{x = o}^{w} \vert ( - {R}_{x , - 1} + 2 {R}_{x , 0} - {P}_{x , 1} ) - a \vert + {\sum }_{y = 0}^{h} \vert ( - {R}_{- 1 , y} + 2 {R}_{0 , y} - {P}_{1 , y} ) - b \vert$$

where R is reconstructed neighbors, P is prediction of the current block, and a and b are variables.
e. For example, which template matching method is used for a video block may be signalled as syntax elements (e.g., a mode index, a syntax parameter, a flag, etc).
f. For example, different template matching methods may be based on different template positions.
   i. The templates may have different lines of samples.
   ii. A template may include samples left to and above to the current block.
   iii. A template may include samples only left to the current block.
   iv. A template may include samples only above to the current block.
   v. A template may include samples of at least one neighboring sample and at least one prediction sample of current block.
   vi. A template may only include neighboring samples.
   vii. A template may only include prediction samples of the current block.

### Motion Candidates Based

5. For example, the coding information of more than one column and/or more than one row of neighboring coded blocks may be used for current video block coding.
   a. For example, the video unit may be coded with Affine merge, Affine Amvp, regular merge, subblock merge, CIIP, GPM, AMVP-Merge, AMVP, Intra, and any variants of them, etc.
   b. For example, the coding information may be intra modes, inter prediction methods, motion vectors, reference index, prediction direction, coordinators/locations of neighboring coded blocks.
   c. For example, the size/dimension of neighboring blocks may be measured by the size/dimension of PU/TU/CU/subblocks or a fixed granular such as 4×4 or 8×8 or 16×16.
   d. For example, M rows of neighboring blocks are considered, wherein M may be a variable depending on how far the current PU/TU/CU/subblock is from the top boundary of the current CTU/CTB.
   i. For example, suppose at most X1 (e.g., X1 is a constant) rows of neighboring blocks are considered, and the distance from the current PU/TU/CU/subblock to the top boundary of the current CTU/CTB is represented by D=func(curblk, ctb_top_boundary) (e.g., D is a variable), then M=X1−D.
      ii. Furthermore, alternatively, only if the current PU/TU/CU/subblock does NOT locate at the top boundary of the CTU/CTB, the value of M conforms to the disclosed rule.
      iii. Furthermore, alternatively, if the current PU/TU/CU/subblock locates at the top boundary of the CTU/CTB (e.g., D=0), then M=X2 (e.g., X2 is a pre-defined constant).
      iv. For example, X2=1 or 2 or 3 or 4 or other constant values.
      v. For example, X1 is a constant.
      vi. For example, X1 may be different from X2.
   e. Alternatively, M rows of neighboring blocks are considered, wherein M may be a predefined constant (such as M>1).
      i. For example, the rule may be applied to a PU/TU/CU/subblock if it is NOT located at the top boundary of the CTU/CTB.
      ii. Alternatively, the rule may be applied to a PU/TU/CU/subblock if it is located at the top boundary of the CTU/CTB.
   f. For example, N columns of neighboring blocks are considered, wherein N may be a variable depending on how far the current PU/TU/CU/subblock is from the left boundary of the current CTU/CTB.
      i. For example, suppose at most Y1 (e.g., Y1 is a constant) columns of neighboring blocks are considered, and the distance from the current PU/TU/CU/subblock to the left boundary of the current CTU/CTB is represented by DD=func(curblk, ctb_left_boundary) (e.g., DD is a variable), then M=Y1−DD.
      ii. Furthermore, alternatively, only if the current PU/TU/CU/subblock does NOT locate at the left boundary of the CTU/CTB, the value of M conforms to the disclosed rule.
      iii. Furthermore, alternatively, if the current PU/TU/CU/subblock locates at the left boundary of the CTU/CTB (e.g., DD=0), then M=Y2 (e.g., Y2 is a pre-defined constant).
      iv. For example, Y2=1 or 2 or 3 or 4 or other constant values.
      v. For example, Y1 is a constant.
      vi. For example, Y1 may be different from Y2.
   g. For example, N columns of neighboring blocks are considered, wherein N may be a constant (such as N>1).
      i. For example, the rule may be applied to a PU/TU/CU/subblock if it is NOT located at the left boundary of the CTU/CTB.
      ii. For example, the rule may be applied to a PU/TU/CU/subblock if it is located at the left boundary of the CTU/CTB.
   h. For example, every PU/TU/CU/subblock of the M rows and/or N columns of neighboring blocks may be checked until the total number of valid candidates meet a pre-defined value.
      i. Alternatively, some PU/TU/CU/subblocks may be checked according to a rule (e.g., every two of them, etc).
      ii. Furthermore, similarity check may be applied for counting the valid candidates.
      i. Furthermore, alternatively, adaptive reordering-based method (e.g., ARMC) may be used to sort the motion/mode candidates of the M rows and/or N columns of neighboring blocks.
6. For example, whether to and/how to apply a template-based method may depend on the position of the current block.
   a. For example, a template-based method cannot be used if the current block is at the above boundary of a CTU (or other regions like VPDU).
   b. For example, a template-based method only be used if the current block is at the above boundary of a CTU (or other regions like VPDU).
   c. For example, a template-based method cannot be used if the current block is at the left boundary of a CTU (or other regions like VPDU).
   d. For example, a template-based method only be used if the current block is at the left boundary of a CTU (or other regions like VPDU).
   e. For example, a template cannot include samples above the current block if the current block is at the above boundary of a CTU (or other regions like VPDU).
   f. For example, a template can include samples above the current block only if the current block is at the above boundary of a CTU (or other regions like VPDU).
   g. For example, a template cannot include samples left to the current block if the current block is at the left boundary of a CTU (or other regions like VPDU).
   h. For example, a template can include samples left the current block only if the current block is at the left boundary of a CTU (or other regions like VPDU).

### History Table Based

7. For example, at least one history based intra mode table may be maintained for a video unit coding.
   a. For example, the history table is updated on-the-fly with decoded block intra mode information.
   b. For example, pruning/redundancy/similarity check may be used to add new candidate to the history table.
   c. For example, a history based intra mode table may be maintained for coding blocks in the current picture.
      i. For example, at most K1 intra mode candidates from previously coded blocks in the current picture may be maintained in the table.
   d. For example, a history based intra mode table may be maintained for coding blocks in the reference picture.
      i. For example, at most K2 intra mode candidates from identified blocks in a reference picture are maintained in the table.
   e. For example, MPM list construction of the current intra block coding may be based on the intra modes in the history table.
      i. For example, a pre-defined number of intra mode candidates may be selected from the history table based on a rule.
      ii. For example, the intra mode candidates may be firstly sorted (such as sorted via a template-based method) and then select some of them for the MPM list generation.
   f. Alternatively, the intra modes in the table may be perceived as pre-defined modes for the current intra block coding.
8. For example, at least one history-based partition information table may be maintained for a video unit coding.
   a. For example, the history table is updated on-the-fly with decoded CU/PU/TU/CTU/CB/PB/TB/CTB partition information.
      i. For example, the partition information of previously coded blocks in the current picture may be taken into account.
      ii. Furthermore, alternatively, the partition information of temporally coded blocks in the reference picture may be taken into account.
   b. For example, pruning/redundancy/similarity check may be used to add new candidate to the history table.
   c. For example, one candidate in the partition table may consist of partition depth (such as QT depth, MTT depth), size of coding tree node, splitting tree information (such as BT or TT, vertical or horizontal at each depth), etc.
   d. For example, the partition information of the current block (e.g., coding tree node) may be derived from the candidate index of the history-based partition table.
      i. For example, a candidate index may be signalled/presented in the bitstream.
      ii. For example, the partition information of the current block (e.g., coding tree node) may be not directly signalled.
   e. For example, whether to use a history-based partition information derivation may be signalled in the bitstream.
      i. For example, a block (e.g., coding tree node) based syntax element (e.g., flag, or mode index) may be signalled for the current block indicating whether to directly signal the partition information or derive the partition information from a history-based partition table.
      ii. For example, a SPS/PPS/PH/SH/CTU/CTB flag may be signalled to represent the allowance of the history-based partition table method at a video unit level higher than a block.
9. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
10. Whether to and/or how to apply the disclosed methods above may be signalled at PB/TB/CB/PU/TU/CU/VPDU/CTU/CTU row/slice/tile/sub-picture/other kinds of region contain more than one sample or pixel.
11. Whether to and/or how to apply the disclosed methods above may be dependent on coded information, such as block size, colour format, single/dual tree partitioning, colour component, slice/picture type.

As used herein, he terms ‘video unit’ or ‘coding unit’ or ‘block’ may represent a coding tree block (CTB), a coding tree unit (CTU), a coding block (CB), a CU, a PU, a TU, a PB, a TB.

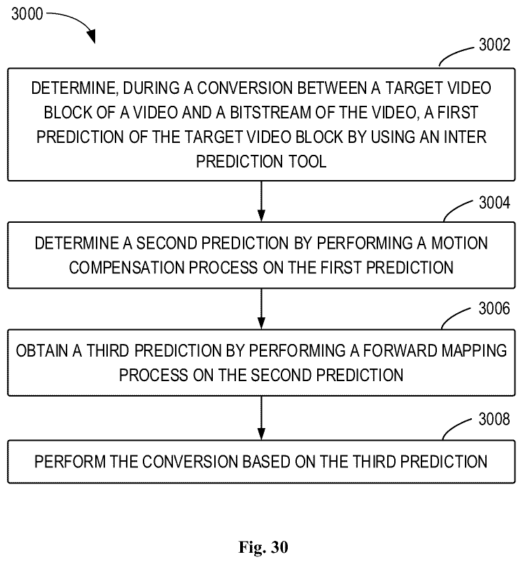

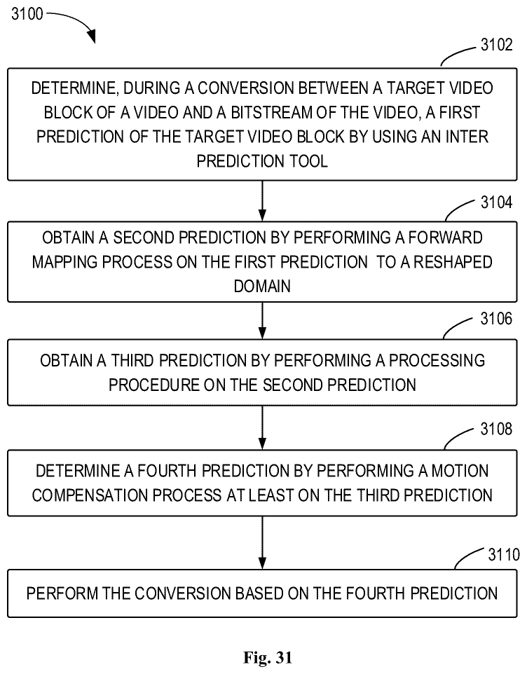

FIG. 30 illustrates a flowchart of a method 3000 for video processing in accordance with some embodiments of the present disclosure. The method 3000 may be implemented during a conversion between a target video block of a video and a bitstream of the video. As shown in FIG. 30, the method 3000 starts at 3002, where a first prediction of the target video block is determined by using an inter prediction tool. At block 3004, a second prediction is determined by performing a motion compensation process on the first prediction. At block 3006, a third prediction is obtained by performing a forward mapping process on the second prediction.

At block 3006, the conversion is performed based on the third prediction. For example, the conversion may include encoding the target video block into the bitstream. For another example, the conversion may include decoding the target video block from the bitstream.

The method 3000 enables the utilization of forward mapping and motion compensation in the prediction of the target video block, which can improve the accuracy of the prediction. In this way, the coding effectiveness and coding efficiency can be improved.

In some embodiments, the motion compensation process comprises an overlapped block motion compensation (OBMC) process.

In some embodiments, the forward mapping process may comprise a forward luma mapping with chroma scaling (LMCS) process. The LMCS process represents a forward mapping process for a luma sample of the target video block, in which the luma sample is converted from an original domain to a reshaped domain by using a piecewise linear model.

In some embodiments, the first prediction comprises an inter prediction of the target video block in an original domain. For example, the inter prediction may comprise a geometric partitioning mode (GPM) inter prediction of the target video block or an inter prediction of a GPM variant mode of the target video block.

In some embodiments, a fourth prediction may be obtained by performing a processing procedure on the third prediction. The conversion may be performed based on the fourth prediction. For example, the processing procedure may comprise determining a weighted blending of the third prediction and a geometric partitioning mode (GPM) intra prediction of the target video block in a reshaped domain.

In some embodiments, the second prediction may be determined by obtaining an original domain OBMC compensated GPM inter prediction by performing an overlapped block motion compensation (OBMC) process on a geometric partitioning mode (GPM) inter prediction of the target video block in an original domain.

In some embodiments, the third prediction may be obtained by obtaining a reshaped domain OBMC compensated GPM inter prediction by applying a forward luma mapping with chroma scaling (LMCS) process on the original domain OBMC compensated GPM inter prediction.

In some embodiments, the fourth prediction may be determined by determining a weighted blending of a reshaped domain GPM intra prediction of the target video block and the reshaped domain OBMC compensated GPM inter prediction to obtain a final OBMC compensated GPM inter-intra blended prediction in the reshaped domain.

In other words, firstly, OBMC may be applied to the GPM inter prediction in the original domain, to get an original domain OBMC compensated GPM inter prediction. Then, a forward LMCS mapping is applied to the original domain OBMC compensated prediction to get a reshaped domain OBMC compensated GPM inter prediction. After that, the reshaped domain GPM intra prediction is further weighted blended with the reshaped OBMC compensated prediction, to get the final OBMC compensated GPM inter-intra blended prediction in the reshaped domain.

According to some embodiments, the consistency between GPM inter-intra prediction, OBMC and LMCS can be improved, and thus the coding effectiveness and coding efficiency can be improved.

In some embodiments, a bitstream of a video is stored in a non-transitory computer-readable recording medium. The bitstream of the video is generated by a method performed by a video processing apparatus. According to the method, a first prediction of a target video block of the video is determined by using an inter prediction tool. A second prediction is determined by performing a motion compensation process on the first prediction. A third prediction is obtained by performing a forward mapping process on the second prediction. The bitstream is generated based on the third prediction.

In some embodiments, a first prediction of a target video block of the video is determined by using an inter prediction tool. A second prediction is determined by performing a motion compensation process on the first prediction. A third prediction is obtained by performing a forward mapping process on the second prediction. The bitstream is generated based on the third prediction. The bitstream is stored in a non-transitory computer-readable recording medium.

FIG. 31 illustrates a flowchart of a method 3100 for video processing in accordance with some embodiments of the present disclosure. The method 3100 may be implemented during a conversion between a target video block of a video and a bitstream of the video. As shown in FIG. 31, the method 3100 starts at 3102, where a first prediction of the target video block is determined by using an inter prediction tool. At block 3104, a second prediction is obtained by performing a forward mapping process on the first prediction to a reshaped domain. At block 3106, a third prediction is obtained by performing a processing procedure on the second prediction. At block 3108, a fourth prediction is determined by performing a motion compensation process at least on the fourth prediction.

At block 3110, the conversion is performed based on the fourth prediction. For example, the conversion may include encoding the target video block into the bitstream. For another example, the conversion may include decoding the target video block from the bitstream.

The method 3100 enables the utilization of motion compensation and forward mapping in the prediction of the target video block, which can improve the accuracy of the prediction. In this way, the coding effectiveness and coding efficiency can be improved.

In some embodiments, the motion compensation process comprises an overlapped block motion compensation (OBMC) process.

In some embodiments, the forward mapping process may comprise a forward luma mapping with chroma scaling (LMCS) process. The LMCS process represents a forward mapping process for a luma sample of the target video block, in which the luma sample is converted from an original domain to a reshaped domain by using a piecewise linear model.

In some embodiments, the first prediction comprises an inter prediction of the target video block, such as a geometric partitioning mode (GPM) inter prediction of the target video block or an inter prediction of a GPM variant mode of the target video block.

In some embodiments, at block 3104, the second prediction may be obtained by obtaining a reshaped domain OBMC compensated GPM inter prediction by applying a forward luma mapping with chroma scaling (LMCS) process on the original domain OBMC compensated GPM inter prediction.

In some embodiments, at block 3106, the third prediction may be obtained by weighting the second prediction with a geometric partitioning mode (GPM) intra prediction of the target video block in a reshaped domain. For example, a weighted blending of a reshaped domain GPM intra prediction of the target video block and the reshaped domain OBMC compensated GPM inter prediction to may be determined obtain a final OBMC compensated GPM inter-intra blended prediction in the reshaped domain.

In some embodiments, at block 3108, the fourth prediction may be determined by obtaining an original domain OBMC compensated GPM inter prediction by performing an overlapped block motion compensation (OBMC) process on a geometric partitioning mode (GPM) inter prediction of the target video block in an original domain.

In other words, firstly, OBMC may be applied to the GPM inter prediction in the original domain, to get an original domain OBMC compensated GPM inter prediction. Then, a forward LMCS mapping is applied to the original domain OBMC compensated prediction to get a reshaped domain OBMC compensated GPM inter prediction. After that, the reshaped domain GPM intra prediction is further weighted blended with the reshaped OBMC compensated prediction, to get the final OBMC compensated GPM inter-intra blended prediction in the reshaped domain.

According to some embodiments, the consistency between GPM inter-intra prediction, OBMC and LMCS can be improved, and thus the coding effectiveness and coding efficiency can be improved.

In some embodiments, a bitstream of a video is stored in a non-transitory computer-readable recording medium. The bitstream of the video is generated by a method performed by a video processing apparatus. According to the method, a first prediction of a target video block of the video is determined by using an inter prediction tool. A second prediction is obtained by performing a forward mapping process on the first prediction to a reshaped domain. A third prediction is obtained by performing a processing procedure on the second prediction. A fourth prediction is determined by performing a motion compensation process at least on the third prediction. The bitstream is generated based on the fourth prediction.

In some embodiments, a first prediction of a target video block of the video is determined by using an inter prediction tool. A second prediction is obtained by performing a forward mapping process on the first prediction to a reshaped domain. A third prediction is obtained by performing a processing procedure on the second prediction. A fourth prediction is determined by performing a motion compensation process at least on the third prediction. The bitstream is generated based on the fourth prediction. The bitstream is stored in a non-transitory computer-readable recording medium.

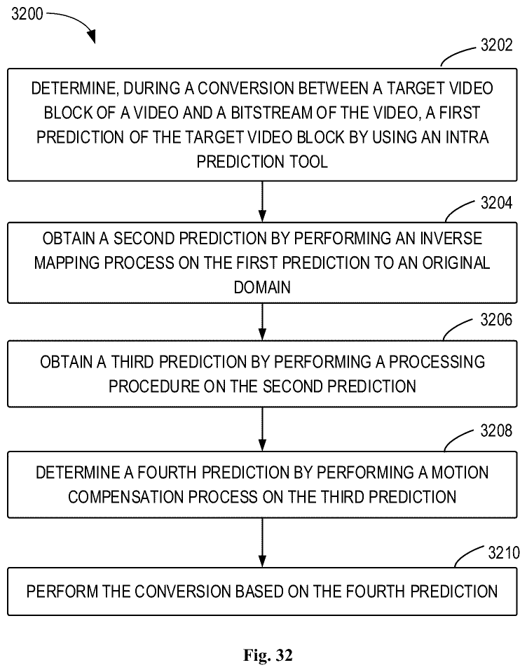

FIG. 32 illustrates a flowchart of a method 3200 for video processing in accordance with some embodiments of the present disclosure. The method 3200 may be implemented during a conversion between a target video block of a video and a bitstream of the video. As shown in FIG. 32, the method 3200 starts at 3202, where a first prediction of the target video block is determined by using an intra prediction tool. At block 3204, a second prediction is obtained by performing an inverse mapping process on the first prediction to an original domain. At block 3206, a third prediction is obtained by performing a processing procedure on the second prediction. At block 3208, a fourth prediction is determined by performing a motion compensation process at least on the fourth prediction.

At block 3210, the conversion is performed based on the fourth prediction. For example, the conversion may include encoding the target video block into the bitstream. For another example, the conversion may include decoding the target video block from the bitstream.

The method 3200 enables the utilization of inverse mapping and motion compensation in the prediction of the target video block, which can improve the accuracy of the prediction. In this way, the coding effectiveness and coding efficiency can be improved.

In some embodiments, the motion compensation process comprises an overlapped block motion compensation (OBMC) process.

In some embodiments, the inverse mapping process may comprise an inverse luma mapping with chroma scaling (LMCS) process. The inverse LMCS process may represents an inverse mapping process on a luma sample of the target video block, which is an inverse operation of a forward mapping process on the luma sample to convert samples of the luma sample in the reshaped domain to an original domain.

In some embodiments, the first prediction comprises a geometric partitioning mode (GPM) intra prediction of the target video block. For example, at block 3202, a geometric partitioning mode (GPM) intra prediction of the target video block may be determined by using a GPM intra prediction tool.

In some embodiments, at block 3204, an inverse mapping process may be performed on the GPM intra prediction to obtain an original domain GPM intra prediction.

In some embodiments, at block 3206, a weighted blending of the original domain GPM intra prediction and an original domain GPM inter prediction of the target video block may be determined to obtain the original domain GPM blended prediction as the third prediction.

In some embodiments, at block 3208, an overlapped block motion compensation (OBMC) process may be performed on the third prediction to obtain an original domain OBMC compensated prediction.

In some embodiments, a forward mapping process may be performed on the original domain OBMC compensated prediction to obtain a reshaped domain OBMC compensated GPM inter-intra prediction. The conversion may be performed based on the reshaped domain OBMC compensated GPM inter-intra prediction.

In some embodiments, the forward mapping process comprises a forward luma mapping with chroma scaling (LMCS) process. The LMCS process may represent a forward mapping process for a luma sample of the target video block, in which the luma sample is converted from an original domain to a reshaped domain by using a piecewise linear model.

In some embodiments, firstly, an inverse LMCS mapping may be applied to the GPM intra prediction, to get an original domain GPM intra prediction. Secondly, the original domain GPM intra prediction is further weighted blended with the original domain GPM inter prediction to get an original domain GPM blended prediction. Thirdly, OBMC is applied to the original domain GPM blended prediction, to get an original domain OBMC compensated prediction. Finally, a forward LMCS mapping is applied to get a reshaped domain OBMC compensated GPM inter-intra prediction.

According to some embodiments, the consistency between GPM inter-intra prediction, OBMC and LMCS can be improved, and thus the coding effectiveness and coding efficiency can be improved.

In some embodiments, a bitstream of a video is stored in a non-transitory computer-readable recording medium. The bitstream of the video is generated by a method performed by a video processing apparatus. According to the method, a first prediction of a target video block of the video is determined by using an intra prediction tool. A second prediction is obtained by performing an inverse mapping process on the first prediction to an original domain. A third prediction is obtained by performing a processing procedure on the second prediction. A fourth prediction is determined by performing a motion compensation process at least on the third prediction. The bitstream is generated based on the fourth prediction.

In some embodiments, a first prediction of a target video block of the video is determined by using an intra prediction tool. A second prediction is obtained by performing an inverse mapping process on the first prediction to an original domain. A third prediction is obtained by performing a processing procedure on the second prediction. A fourth prediction is determined by performing a motion compensation process at least on the third prediction. The bitstream is generated based on the fourth prediction. The bitstream is stored in a non-transitory computer-readable recording medium.

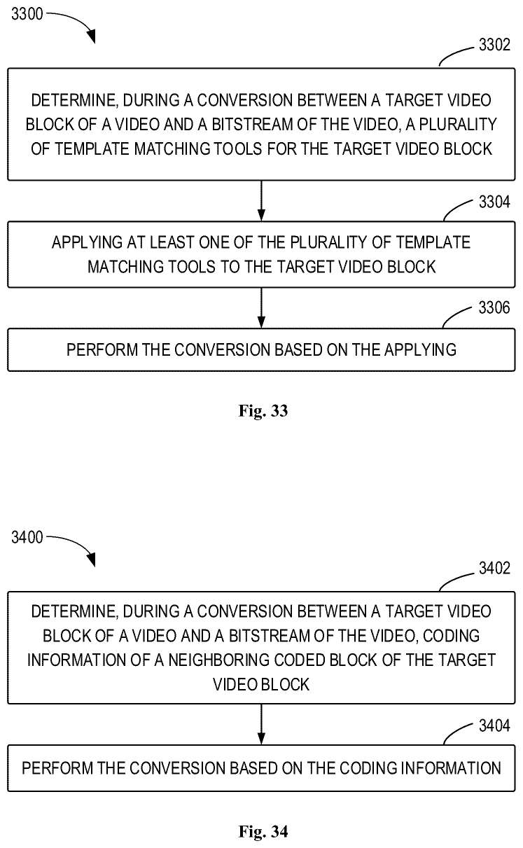

FIG. 33 illustrates a flowchart of a method 3300 for video processing in accordance with some embodiments of the present disclosure. The method 3300 may be implemented during a conversion between a target video block of a video and a bitstream of the video. As shown in FIG. 33, the method 3300 starts at 3302, where a plurality of template matching tools is determined for the target video block. At block 3304, at least one of the plurality of template matching tools is applied to the target video block.

At block 3306, the conversion is performed based on the applying. For example, the conversion may include encoding the target video block into the bitstream. For another example, the conversion may include decoding the target video block from the bitstream.

The method 3300 enables the utilization of at least one template matching tools on the target video block. In this way, the coding effectiveness and coding efficiency can be improved.

In some embodiments, the target video block is coded by an intra prediction coding tool. By way of example, the intra prediction coding tool may comprise at least one of the following: a template-based intra mode derivation (TIMD) coding tool, a variant of the TIMD coding tool, a decoder side mode derivation (DIMD) coding tool, a variant of the DIMD coding tool, or a most probable mode (MPM) candidates sorting coding tool.

In some embodiments, the target video block may be coded by using at least one inter prediction coding tool. For example, the at least one inter prediction coding tool may comprise at least one of the following: a geometric partitioning mode (GPM) coding tool, a GPM template matching (GPM-TM) coding tool, a variant of the GPM coding tool, a combined inter and intra prediction (CIIP) coding tool, a CIIP template matching (CIIP-TM) coding tool, a variant of the CIIP coding tool, a regular merge coding tool, a template matching TM-merge coding tool, a variant of regular merge coding tool, an advanced motion vector predication (AMVP) coding tool, a TM-AMVP coding tool, a variant of AMVP coding tool, a merge mode with motion vector difference (MMVD) coding tool, a TM-MMVD coding tool, a variant of MMVD coding tool, an affine coding tool, a TM-affine coding tool, or a variant of affine coding tool.

In some embodiments, the at least one inter prediction coding tool may be ordered. The target video block may be coded by using the at least one inter prediction tool according to the ordering.

In some embodiments, at block 3304, at least one of the plurality of template matching tools may be applied to the target video block by reordering motion candidates of the target video block may be reordered by using the plurality of template matching tools.

In some embodiments, an adaptive reordering merge candidates (ARMC) process may be applied on the motion candidates. By way of example, the motion candidates may comprise one of the following: regular merge candidates, combined inter and intra prediction (CIIP) merge candidates, geometric partitioning mode (GPM) merge candidates, merge mode with motion vector difference (MMVD) merge candidates, advanced motion vector predication (AMVP) candidates, affine candidates, affine merge candidates, or affine AMVP candidates.

In some embodiments, at block 3304, at least one of the plurality of template matching tools may be applied to the target video block by determining a number of motion candidates based on at least one of: a template matching tool of the plurality of template matching tool or a prediction coding tool and selecting the number of motion candidates from the motion candidates based on the reordering.

In some embodiments, a first template matching tool of the plurality of template matching tools uses a first cost metric. A second template matching tool of the plurality of template matching tools uses a second cost metric different from the first cost metric.

In some embodiments, the plurality of template matching tools is based on a plurality of cost metrics. For example, the plurality of cost metrics may comprise a cost metric based on a discontinuity measure across block boundary.

In some embodiments, the plurality of cost metrics comprises a further cost metric based on a sum of absolute second derivatives in a residual domain for an above row and a left column of the target video block. For example, the further cost metric may comprise: cost=Σₓ₌ₒ^{w}(−R_{x,-1}+2R_{x,0}−P_{x,1})−a|+Σ_{y=o}^{h}(−R_{-1,y}+2R_{0,y}−P_{1,y})−b|, where R denotes h reconstructed neighbors of the target video block, P denotes prediction of the target video block, and a and b are variables.

In some embodiments, information regarding the at least one template matching tool may be included in at least one syntax element in the bitstream. For example, the information may indicate a target template matching tool of the at least one template matching tool to be used for the target video block.

In some embodiments, the at least one syntax element may comprise at least one of the following: a mode index, a syntax parameter, or a flag.

In some embodiments, the plurality of template matching tools is based on a plurality of templates. By way of example, a first template of the plurality of templates is located at a first position. A second template of the plurality of templates is located at a second position different from the first position.

In some embodiments, a first template of the plurality of templates comprises a first set of lines of samples. A second template of the plurality of templates comprises a second set of lines of samples different from the first set of lines of samples.

In some embodiments, a template of the plurality of templates may comprise samples left to the target video block. Alternatively, or in addition, in some embodiments, a template of the plurality of templates may comprise samples above to the target video block.

In some embodiments, a template of the plurality of templates may comprise samples of at least one neighboring sample of the target video block. Alternatively, or in addition, in some embodiments, a template of the plurality of templates may comprise samples of at least one prediction sample of the target video block.

In some embodiments, a bitstream of a video is stored in a non-transitory computer-readable recording medium. The bitstream of the video is generated by a method performed by a video processing apparatus. According to the method, a plurality of template matching tools is determined for a target video block of the video. At least one of the plurality of template matching tools is applied to the target video block. The bitstream is generated based on the applying.

In some embodiments, a plurality of template matching tools may be determined for a target video block of the video. At least one of the plurality of template matching tools is applied to the target video block. The bitstream is generated based on the applying. The bitstream is stored in a non-transitory computer-readable recording medium.

FIG. 34 illustrates a flowchart of a method 3400 for video processing in accordance with some embodiments of the present disclosure. The method 3400 may be implemented during a conversion between a target video block of a video and a bitstream of the video. As shown in FIG. 34, the method 3400 starts at 3402, where coding information of a neighboring coded block of the target video block is determined.

At block 3404, the conversion is performed based on the coding information. For example, the conversion may include encoding the target video block into the bitstream. For another example, the conversion may include decoding the target video block from the bitstream.

The method 3400 enables the utilization of coding information of the neighboring coded block of the target video block. In this way, the coding effectiveness and coding efficiency can be improved.

In some embodiments, at block 3404, the target video block may be coded by using one of the following: an affine merge coding tool, an affine advanced motion vector predication (AMVP) coding tool, a regular merge coding tool, a subblock merge coding tool, a combined inter and intra prediction (CIIP) coding tool, a geometric partitioning mode (GPM) coding tool, an AMVP-merge coding tool, an intra coding tool, or a variant of one of the above coding tools.

In some embodiments, the coding information may comprise at least one of the following: an intra mode of the neighbor coded block, an inter prediction coding tool of the neighbor coded block, a motion vector of the neighbor coded block, a reference index of the neighbor coded block, a prediction direction of the neighbor coded block, a coordinator of the neighbor coded block, or a location of the neighbor coded block.

In some embodiments, a size or dimension of the neighbor coded block may be determined based on a size or dimension of a coding unit. By way of example, the coding unit may comprise one of the following: a prediction unit (PU), a transform unit (TU), a coding unit (CU), a subblock, or a fixed granular unit. For example, the fixed granular unit may comprise one of: a 4 times 4 unit, an eight times eight unit, or a sixteen times sixteen unit.

In some embodiments, the coding information comprises the coding information of a region of the neighbor coded block. By way of example, the region may comprise at least one of the following: a set of rows of the neighbor coded block, or a set of columns of the neighbor coded block. That is, the coding information of more than one column and/or more than one row of neighboring coded blocks may be used for current video block coding.

In some embodiments, a first number of rows in the set of rows may be determined based on a first distance between a coding unit and a top boundary of a current coding tree unit (CTU) or between the coding unit and a top boundary of a current coding tree block (CTB). By way of example, the coding unit may comprise one of the following: a current prediction unit (PU), a current transform unit (TU), a current coding unit (CU), or a current subblock.

In some embodiments, the first number may be determined by subtracting the first distance from a first threshold number of rows of the neighbor coded block. The first distance may be determined by using D=func(curblk, ctb_top_boundary), where D denotes the first difference, func( ) denotes a distance metric, curblk denotes the coding unit, and ctb_top_boundary denotes the top boundary of the CTU or CTB.

In some embodiments, if the coding unit does not locate at the top boundary, the first number may be determined based on the first distance. Alternatively, or in addition, in some embodiments, if the coding unit locates at the top boundary, a first predefined constant may be determined as the first number. For example, the first predefined constant may be 1, 2, 3, 4 or a further constant.

In some embodiments, the first predefined constant is different from a first threshold number of rows of the neighbor coded block. By way of example, the first threshold number may comprise a constant.

In some embodiments, a first number of rows in the set of rows may be determined based on a second predefined constant. By way of example, the second predefined constant may be greater than 1.

In some embodiments, if the coding unit does not locate or locates at a top boundary of a coding tree unit (CTU) or coding tree block (CTB), the first number may be determined based on the second predefined constant.

In some embodiments, the coding unit may comprise a current prediction unit (PU), a current transform unit (TU), a current coding unit (CU), or a current subblock.

Alternatively, or in addition, in some embodiments, a second number of columns in the set of columns may be determined based on a second distance between a coding unit and a left boundary of a current coding tree unit (CTU) or between the coding unit and a left boundary of a current coding tree block (CTB). By way of example, the coding unit may comprise one of the following: a current prediction unit (PU), a current transform unit (TU), a current coding unit (CU), or a current subblock.

In some embodiments, the second number may be determined by subtracting the second distance from a second threshold number of columns of the neighbor coded block. For example, the second distance may be determined by using DD=func(curblk, ctb_left_boundary), where DD denotes the second difference, func( ) denotes a distance metric, curblk denotes the coding unit, and ctb_left_boundary denotes the left boundary of the CTU or CTB.

In some embodiments, if the coding unit does not locate at the left boundary, the second number may be determined based on the second distance. Alternatively, or in addition, in some embodiments, if the coding unit locates at the left boundary, a third predefined constant may be determined as the second number. For example, the third predefined constant may be 1, 2, 3, 4 or a further constant.

In some embodiments, the third predefined constant is different from a second threshold number of columns of the neighbor coded block. By way of example, the second threshold number may comprise a constant.

In some embodiments, a second number of columns in the set of columns may be determined based on a fourth predefined constant. In some embodiments, the fourth predefined constant is greater than 1.

In some embodiments, if the coding unit does not locate or locates at a left boundary of a coding tree unit (CTU) or coding tree block (CTB), the second number may be determined based on the fourth predefined constant.

In some embodiments, the coding unit comprises one of the following: a current prediction unit (PU), a current transform unit (TU), a current coding unit (CU), or a current subblock.

In some embodiments, at block 3404, whether a candidate of at least one coding unit in the region of the neighbor coded block is valid may be determined. A third number of valid candidates may be determined. If the third number meets a predefined value, the conversion may be performed based on the third number of valid candidates. In some embodiments, the third number may be determined by using a similarity check.

In some embodiments, the at least one coding unit comprises at least one of the following: current prediction unit (PU), a current transform unit (TU), a current coding unit (CU), or a current subblock.

In some embodiments, motion candidates or mode candidates of the region of the neighbor coded block may be sorted. The coding information may be determined based on the sorting. For example, the motion candidates or mode candidates may be sorted by using an adaptive reordering-based coding tool. By way of example, the adaptive reordering-based coding tool may comprise an adaptive reordering merge candidates (ARMC) coding tool.

In some embodiments, a bitstream of a video is stored in a non-transitory computer-readable recording medium. The bitstream of the video is generated by a method performed by a video processing apparatus. According to the method, coding information of a neighboring coded block of a target video block of the video is determined. The bitstream is generated based on the coding information.

In some embodiments, coding information of a neighboring coded block of a target video block of the video is determined. The bitstream is generated based on the coding information. The bitstream is stored in a non-transitory computer-readable recording medium.

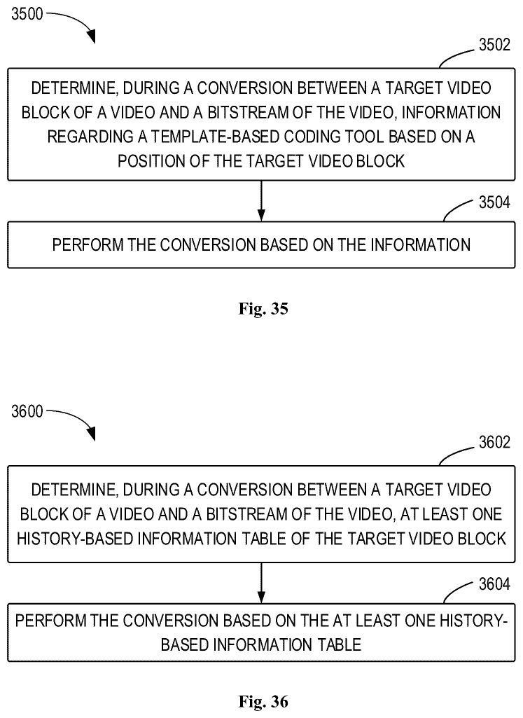

FIG. 35 illustrates a flowchart of a method 3500 for video processing in accordance with some embodiments of the present disclosure. The method 3500 may be implemented during a conversion between a target video block of a video and a bitstream of the video. As shown in FIG. 35, the method 3500 starts at 3502, where information regarding a template-based coding tool based on a position of a target video block of the video is determined.

At block 3504, the conversion is performed based on the information. For example, the conversion may include encoding the target video block into the bitstream. For another example, the conversion may include decoding the target video block from the bitstream.

The method 3500 enables the utilization of template-based coding tool based on a position of a target video block. In this way, the coding effectiveness and coding efficiency can be improved.

In some embodiments, the information comprises at least one of the following: whether to apply the template-based coding tool, or how to apply the template-based coding tool.

In some embodiments, at block 3502, if the target video block is at an above or left boundary of a coding unit, the information may be determined to indicate one of the following: not to use the template-based coding tool, or to use the template-based coding tool.

Alternatively, or in addition, in some embodiments, at block 3502, if the target video block is at an above boundary of a coding unit, the information may be determined to indicate one of the following: that samples above the target video block are absent from a template for the target video block, or that the template comprises the samples above the target video block.

In some embodiments, at block 3502, if the target video block is at a left boundary of a coding unit, the information may be determined to indicate one of the following: that samples left to the target video block are absent from a template for the target video block, or that the template comprises the samples left to the target video block.

In some embodiments, the coding unit may comprise a coding tree unit (CTU), a virtual pipeline data unit (VPDU), or a coding region.

In some embodiments, a bitstream of a video is stored in a non-transitory computer-readable recording medium. The bitstream of the video is generated by a method performed by a video processing apparatus. According to the method, information regarding a template-based coding tool based on a position of a target video block of the video is determined. The bitstream is generated based on the information.

In some embodiments, information regarding a template-based coding tool based on a position of a target video block of the video is determined. The bitstream is generated based on the information. The bitstream is stored in a non-transitory computer-readable recording medium.

FIG. 36 illustrates a flowchart of a method 3600 for video processing in accordance with some embodiments of the present disclosure. The method 3600 may be implemented during a conversion between a target video block of a video and a bitstream of the video. As shown in FIG. 36, the method 3600 starts at 3602, where at least one history-based information table of a target video block of the video is determined.

At block 3604, the conversion is performed based on the at least one history-based information table. For example, the conversion may include encoding the target video block into the bitstream. For another example, the conversion may include decoding the target video block from the bitstream.

The method 3600 enables the utilization of at least one history-based information table. In this way, the coding effectiveness and coding efficiency can be improved.

In some embodiments, the at least one history-based information table may be maintained for the target video block. In some embodiments, the at least one history-based information table comprises a history-based intra mode table.

In some embodiments, the history-based intra mode table may be updated on-the-fly with decoded block intra mode information. By way of example, a new candidate may be added to the history-based intra mode table by using at least one of the following procedures: a pruning procedure, a redundancy check procedure, or a similarity check procedure.

In some embodiments, the history-based intra mode table may be maintained for coding blocks in a current picture. By way of example, a first number of intra mode candidates from a previously coded block in the current picture may be maintained in the history-based intra mode table. For example, at most KI intra mode candidates from previously coded blocks in the current picture may be maintained in the table.

In some embodiments, the history-based intra mode table for coding blocks in a reference picture may be maintained. By way of example, a second number of intra mode candidates from an identified block in the reference picture in the history-based intra mode table may be maintained. For example, at most K2 intra mode candidates from identified blocks in a reference picture are maintained in the table.

In some embodiments, at block 3604, a most probable mode (MPM) list of the target video block being intra coded may be determined based on at least one intra mode in the history-based intra mode table.

In some embodiments, the at least one intra mode from the history-based intra mode table may be selected based on a rule. By way of example, a number of intra mode of the at least one intra mode may comprise a predefined number.

In some embodiments, a plurality of intra mode candidates in the history-based intra mode table may be sorted. The at least one intra mode may be selected from the history-based intra mode table based on the sorting. In some embodiments, the plurality of intra mode candidates may be sorted by using a template-based tool.

In some embodiments, an intra mode in the history-based intra mode table is a predefined mode for the target video block being intra coded.

In some embodiments, the at least one history-based information table comprises a history-based partition information table.

In some embodiments, the history-based partition information table may be updated on-the-fly with decoded partition information. By way of example, the decoded partition information may comprise decoded partition information for at least one of the following: a coding unit (CU), a prediction unit (PU), a transform unit (TU), a coding tree unit (CTU), a coding block (CB), a prediction block (PB), a transform block (TB), or a coding tree block (CTB).

In some embodiments, the decoded partition information may comprise partition information of a previously coded block in a current picture. Alternatively, or in addition, in some embodiments, the decoded partition information may comprise partition information of a temporally coded block in a reference picture.

In some embodiments, a new candidate may be added in the history-based partition information table by using at least one of the following procedures: a pruning procedure, a redundancy check procedure, or a similarity check procedure.

In some embodiments, a candidate in the history-based partition information table may comprise at least one of the following: a partition depth, a size of coding tree node, or splitting tree information. By way of example, the partition depth may comprise at least one of: a quadtree (QT) depth or a multi-type tree (MTT) depth.

In some embodiments, the splitting tree information comprises at least one of: binary tree (BT) or ternary tree (TT) splitting, or vertical or horizontal at a depth.

In some embodiments, at block 3604, partition information of the target video block may be determined based on a candidate index in the history-based partition information table. The conversion may be performed based on the partition information. In some embodiments, the target video block comprises a coding tree node.

In some embodiments, the candidate index may be included in the bitstream. Alternatively, or in addition, in some embodiments, the partition information of the target video block is not directly included in the bitstream.

In some embodiments, whether to use the history-based partition information table in the conversion may be indicated in the bitstream. By way of example, whether to use the history-based partition information table may be indicated in a block-based syntax element. For example, the block-based syntax element may comprise at least one of: a flag, or a mode index.

In some embodiments, whether to use the history-based partition information table comprises one of: whether to include the partition information of the target video block in the bitstream or determine the partition information of the target video block by using the history-based partition information table.

In some embodiments, whether to use the history-based partition information table is indicated in at least one of the following: a sequence parameter set (SPS) flag, a Picture Parameter Set (PPS) flag, a picture header (PH) flag, a slice header (SH) flag, a coding tree unit (CTU) flag, or a coding tree block (CTB) flag.

In some embodiments, whether to use the history-based partition information table comprises an allowance of using the history-based partition information table at a video unit level higher than the target video block.

In some embodiments, a bitstream of a video is stored in a non-transitory computer-readable recording medium. The bitstream of the video is generated by a method performed by a video processing apparatus. According to the method, at least one history-based information table of a target video block of the video is determined. The bitstream is generated based on the at least one history-based information table.

In some embodiments, at least one history-based information table of a target video block of the video is determined. The bitstream is generated based on the at least one history-based information table. The bitstream is stored in a non-transitory computer-readable recording medium.

In some example embodiments, second information on whether to and/or how to apply the method 3000 and/or method 3100 and/or method 3200 and/or method 3300 and/or method 3400 and/or method 3500 and/or method 3600 may be indicated in the bitstream. For example, the second information may be indicated at: a sequence level, a group of pictures level, a picture level, a slice level or a tile group level. For a further example, the second information may be indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header. For a still further example, the second information may be indicated in a region containing more than one sample or pixel. The region may comprise: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, the second information may depend on coded information. For example, the coded information may comprise: a coding mode, a block size, a colour format, a single or dual tree partitioning, a colour component, a slice type, or a picture type.

It is to be understood that the above method 3000 and/or method 3100 and/or method 3200 and/or method 3300 and/or method 3400 and/or method 3500 and/or method 3600 may be used in combination or separately. Any suitable combination of these methods may be applied. Scope of the present disclosure is not limited in this regard.

Implementations of the present disclosure can be described in view of the following clauses, the features of which can be combined in any reasonable manner.

Clause 1. A method for video processing, comprising: determining, during a conversion between a target video block of a video and a bitstream of the video, a first prediction of the target video block by using an inter prediction tool; determining a second prediction by performing a motion compensation process on the first prediction; obtaining a third prediction by performing a forward mapping process on the second prediction; and performing the conversion based on the third prediction.

Clause 2. The method of clause 1, wherein the motion compensation process comprises an overlapped block motion compensation (OBMC) process.

Clause 3. The method of clause 1 or clause 2, wherein the forward mapping process comprises a forward luma mapping with chroma scaling (LMCS) process.

Clause 4. The method of clause 3, wherein the forward LMCS process comprises a forward mapping process for a luma sample of the target video block, in which the luma sample is converted from an original domain to a reshaped domain by using a piecewise linear model.

Clause 5. The method of any of clauses 1-4, wherein the first prediction comprises an inter prediction of the target video block in an original domain.

Clause 6. The method of clause 5, wherein the inter prediction comprises one of the following: a geometric partitioning mode (GPM) inter prediction of the target video block, or an inter prediction of a GPM variant mode of the target video block.

Clause 7. The method of clause 5 or clause 6, further comprising: obtaining a fourth prediction by performing a processing procedure on the third prediction; and wherein performing the conversion comprises: performing the conversion based on the fourth prediction.

Clause 8. The method of clause 7, wherein obtaining the fourth prediction by performing the processing procedure comprises: determining a weighted blending of the third prediction and a geometric partitioning mode (GPM) intra prediction of the target video block in a reshaped domain to be the fourth prediction.

Clause 9. The method of clause 7 or clause 8, wherein determining the second prediction by performing the motion compensation process on the first prediction comprises: obtaining an original domain OBMC compensated GPM inter prediction by performing an overlapped block motion compensation (OBMC) process on a geometric partitioning mode (GPM) inter prediction of the target video block in an original domain.

Clause 10. The method of clause 9, wherein obtaining the third prediction by performing the forward mapping process on the second prediction comprises: obtaining a reshaped domain OBMC compensated GPM inter prediction by applying a forward luma mapping with chroma scaling (LMCS) process on the original domain OBMC compensated GPM inter prediction.

Clause 11. The method of clause 10, wherein obtaining the fourth prediction by performing the processing procedure on the third prediction comprises: determining a weighted blending of a reshaped domain GPM intra prediction of the target video block and the reshaped domain OBMC compensated GPM inter prediction to obtain a final OBMC compensated GPM inter-intra blended prediction in the reshaped domain.

Clause 12. A method for video processing, comprising: determining, during a conversion between a target video block of a video and a bitstream of the video, a first prediction of the target video block by using an inter prediction tool; obtaining a second prediction by performing a forward mapping process on the first prediction to a reshaped domain; obtaining a third prediction by performing a processing procedure on the second prediction; determining a fourth prediction by performing a motion compensation process at least on the third prediction; and performing the conversion based on the fourth prediction.

Clause 13. The method of clause 12, wherein the first prediction comprises one of the following: a geometric partitioning mode (GPM) inter prediction of the target video block, or an inter prediction of a GPM variant mode of the target video block.

Clause 14. The method of clause 12 or clause 13, wherein the motion compensation process comprises an overlapped block motion compensation (OBMC) process.

Clause 15. The method of any of clauses 12-14, wherein the forward mapping process comprises a forward luma mapping with chroma scaling (LMCS) process.

Clause 16. The method of clause 15, wherein the forward LMCS process comprises a forward mapping process for a luma sample of the target video block, in which the luma sample is converted from an original domain to a reshaped domain by using a piecewise linear model.

Clause 17. The method of any of clauses 12-16, further comprising: performing the forward mapping process on a further inter prediction used in the motion compensation process.

Clause 18. The method of clause 17, wherein the motion compensation process is performed in a reshaped domain.

Clause 19. The method of any of clauses 12-18, wherein obtaining the third prediction by performing the processing procedure on the second prediction comprises: determining a weighted blending of the second prediction and a geometric partitioning mode (GPM) intra prediction to be the third prediction.

Clause 20. The method of any of clauses 12-19, wherein obtaining the second prediction by performing the forward mapping process on the first prediction comprises: obtaining a reshaped domain GPM inter prediction by performing a forward luma mapping with chroma scaling (LMCS) process on a geometric partitioning mode (GPM) inter prediction.

Clause 21. The method of clause 20, wherein obtaining the third prediction by performing the processing procedure on the second prediction comprises: obtaining a reshaped domain GPM blended prediction as the third prediction by determining a weighted blending of the reshaped domain GPM inter prediction and a reshaped domain GPM intra prediction.

Clause 22. The method of clause 21, further comprising: performing the forward LMCS mapping process on a further inter prediction used in the motion compensation process to obtain a further reshaped domain inter prediction.

Clause 23. The method of clause 22, wherein determining the fourth prediction by performing the motion compensation process at least on the third prediction comprises: performing an overlapped block motion compensation (OBMC) process on the reshaped domain GPM blended prediction and the further reshaped domain inter prediction.

Clause 24. A method for video processing, comprising: determining, during a conversion between a target video block of a video and a bitstream of the video, a first prediction of the target video block by using an intra prediction tool; obtaining a second prediction by performing an inverse mapping process on the first prediction to an original domain; obtaining a third prediction by performing a processing procedure on the second prediction; determining a fourth prediction by performing a motion compensation process on the third prediction; and performing the conversion based on the fourth prediction.

Clause 25. The method of clause 24, wherein the motion compensation process comprises an overlapped block motion compensation (OBMC) process.

Clause 26. The method of clause 24 or clause 25, wherein the inverse mapping process comprises an inverse luma mapping with chroma scaling (LMCS) process.

Clause 27. The method of clause 26, wherein the inverse LMCS process comprises an inverse mapping process on a luma sample of the target video block, which is an inverse operation of a forward mapping process on the luma sample to convert samples of the luma sample in the reshaped domain to an original domain.

Clause 28. The method of any of clauses 24-27, wherein the first prediction comprises a geometric partitioning mode (GPM) intra prediction of the target video block.

Clause 29. The method of clause 28, wherein obtaining the second prediction by performing an inverse mapping process on the first prediction comprises: performing an inverse luma mapping with chroma scaling (LMCS) process on the GPM intra prediction to obtain an original domain GPM intra prediction.

Clause 30. The method of clause 29, wherein obtaining the third prediction by performing the processing procedure on the second prediction comprises: determining a weighted blending of the original domain GPM intra prediction and an original domain GPM inter prediction of the target video block to obtain the original domain GPM blended prediction as the third prediction.

Clause 31. The method of clause 30, wherein determining the fourth prediction by performing the motion compensation process on the third prediction comprises: performing an overlapped block motion compensation (OBMC) process on the third prediction to obtain an original domain OBMC compensated prediction.

Clause 32. The method of clause 31, further comprising: performing a forward mapping process on the original domain OBMC compensated prediction to obtain a reshaped domain OBMC compensated GPM inter-intra prediction; and wherein performing the conversion comprises: performing the conversion based on the reshaped domain OBMC compensated GPM inter-intra prediction.

Clause 33. The method of clause 32, wherein the forward mapping process comprises a forward luma mapping with chroma scaling (LMCS) process.

Clause 34. The method of clause 33, wherein the LMCS process comprises a forward mapping process for a luma sample of the target video block, in which the luma sample is converted from an original domain to a reshaped domain by using a piecewise linear model.

Clause 35. A method for video processing, comprising: determining, during a conversion between a target video block of a video and a bitstream of the video, a plurality of template matching tools for the target video block; applying at least one of the plurality of template matching tools to the target video block; and performing the conversion based on the applying.

Clause 36. The method of clause 35, wherein the target video block is coded by an intra prediction coding tool.

Clause 37. The method of clause 36, wherein the intra prediction coding tool comprises at least one of the following: a template-based intra mode derivation (TIMD) coding tool, a variant of the TIMD coding tool, a decoder side mode derivation (DIMD) coding tool, a variant of the DIMD coding tool, or a most probable mode (MPM) candidates sorting coding tool.

Clause 38. The method of any of clauses 35-37, further comprising: coding the target video block by using at least one inter prediction coding tool.

Clause 39. The method of clause 38, wherein the at least one inter prediction coding tool comprises at least one of the following: a geometric partitioning mode (GPM) coding tool, a GPM template matching (GPM-TM) coding tool, a variant of the GPM coding tool, a combined inter and intra prediction (CIIP) coding tool, a CIIP template matching (CIIP-TM) coding tool, a variant of the CIIP coding tool, a regular merge coding tool, a template matching TM-merge coding tool, a variant of regular merge coding tool, an advanced motion vector predication (AMVP) coding tool, a TM-AMVP coding tool, a variant of AMVP coding tool, a merge mode with motion vector difference (MMVD) coding tool, a TM-MMVD coding tool, a variant of MMVD coding tool, an affine coding tool, a TM-affine coding tool, or a variant of affine coding tool.

Clause 40. The method of clause 38 or clause 39, wherein coding the target video block by using the at least one inter prediction coding tool comprises: ordering the at least one inter prediction coding tool; and coding the target video block by using the at least one inter prediction tool according to the ordering.

Clause 41. The method of any of clauses 35-40, wherein applying at least one of the plurality of template matching tools to the target video block comprises: reordering motion candidates of the target video block by using the plurality of template matching tools.

Clause 42. The method of clause 41, wherein reordering the motion candidates comprises: applying an adaptive reordering merge candidates (ARMC) process on the motion candidates.

Clause 43. The method of clause 29 or clause 42, wherein the motion candidates comprise one of the following: regular merge candidates, combined inter and intra prediction (CIIP) merge candidates, geometric partitioning mode (GPM) merge candidates, merge mode with motion vector difference (MMVD) merge candidates, advanced motion vector predication (AMVP) candidates, affine candidates, affine merge candidates, or affine AMVP candidates.

Clause 44. The method of any of clauses 41-43, wherein applying at least one of the plurality of template matching tools to the target video block comprises: determining a number of motion candidates based on at least one of: a template matching tool of the plurality of template matching tool or a prediction coding tool; selecting the number of motion candidates from the motion candidates based on the reordering.

Clause 45. The method of any of clauses 35-44, wherein a first template matching tool of the plurality of template matching tools uses a first cost metric, and a second template matching tool of the plurality of template matching tools uses a second cost metric different from the first cost metric.

Clause 46. The method of any of clauses 35-45, wherein the plurality of template matching tools is based on a plurality of cost metrics.

Clause 47. The method of clause 46, wherein the plurality of cost metrics comprises a cost metric based on a discontinuity measure across block boundary.

Clause 48. The method of clause 46 or clause 47, wherein the plurality of cost metrics comprises a further cost metric based on a sum of absolute second derivatives in a residual domain for an above row and a left column of the target video block.

Clause 49. The method of clause 48, wherein the further cost metric comprises: cost=Σₓ₌ₒ^{w}(−R_{x,-1}+2R_{x,0}−P_{x,1})−a|+Σ_{y=o}^{h}(−R_{-1,y}+2R_{0,y}−P_{1,y})−b|, where R denotes reconstructed neighbors of the target video block, P denotes prediction of the target video block, and a and b are variables.

Clause 50. The method of any of clauses 35-49, further comprising: including information regarding the at least one template matching tool in at least one syntax element in the bitstream.

Clause 51. The method of clause 50, wherein the information indicates a target template matching tool of the at least one template matching tool to be used for the target video block.

Clause 52. The method of clause 50 or clause 51, wherein the at least one syntax element comprises at least one of the following: a mode index, a syntax parameter, or a flag.

Clause 53. The method of any of clauses 35-52, wherein the plurality of template matching tools is based on a plurality of templates.

Clause 54. The method of clause 53, wherein a first template of the plurality of templates is located at a first position, and a second template of the plurality of templates is located at a second position different from the first position.

Clause 55. The method of clause 53 or clause 54, wherein a first template of the plurality of templates comprises a first set of lines of samples, and a second template of the plurality of templates comprises a second set of lines of samples different from the first set of lines of samples.

Clause 56. The method of any of clauses 53-55, wherein a template of the plurality of templates comprises at least one of the following: samples left to the target video block, or samples above to the target video block.

Clause 57. The method of any of clauses 53-56, wherein a template of the plurality of templates comprises at least one of the following: samples of at least one neighboring sample of the target video block, or samples of at least one prediction sample of the target video block.

Clause 58. A method for video processing, comprising: determining, during a conversion between a target video block of a video and a bitstream of the video, coding information of a neighboring coded block of the target video block; and performing the conversion based on the coding information.

Clause 59. The method of clause 58, wherein performing the conversion comprises: coding the target video block by using one of the following: an affine merge coding tool, an affine advanced motion vector predication (AMVP) coding tool, a regular merge coding tool, a subblock merge coding tool, a combined inter and intra prediction (CIIP) coding tool, a geometric partitioning mode (GPM) coding tool, an AMVP-merge coding tool, an intra coding tool, or a variant of one of the above coding tools.

Clause 60. The method of clause 58 or clause 59, wherein the coding information comprises at least one of the following: an intra mode of the neighbor coded block, an inter prediction coding tool of the neighbor coded block, a motion vector of the neighbor coded block, a reference index of the neighbor coded block, a prediction direction of the neighbor coded block, a coordinator of the neighbor coded block, or a location of the neighbor coded block.

Clause 61. The method of any of clauses 58-60, further comprising: determining a size or dimension of the neighbor coded block based on a size or dimension of a coding unit.

Clause 62. The method of clause 61, wherein the coding unit comprises one of the following: a prediction unit (PU), a transform unit (TU), a coding unit (CU), a subblock, or a fixed granular unit.

Clause 63. The method of clause 62, wherein the fixed granular unit comprises one of: a 4 times 4 unit, an eight times eight unit, or a sixteen times sixteen unit.

Clause 64. The method of any of clauses 58-63, wherein the coding information comprises the coding information of a region of the neighbor coded block, the region comprises at least one of the following: a set of rows of the neighbor coded block, or a set of columns of the neighbor coded block.

Clause 65. The method of clause 64, further comprising: determining a first number of rows in the set of rows based on a first distance between a coding unit and a top boundary of a current coding tree unit (CTU) or between the coding unit and a top boundary of a current coding tree block (CTB).

Clause 66. The method of clause 65, wherein the coding unit comprises one of the following: a current prediction unit (PU), a current transform unit (TU), a current coding unit (CU), or a current subblock.

Clause 67. The method of clause 65 or clause 66, wherein determining the first number comprises: determining the first number by subtracting the first distance from a first threshold number of rows of the neighbor coded block, wherein the first distance is determined by using D=func(curblk, ctb_top_boundary), where D denotes the first difference, func( ) denotes a distance metric, curblk denotes the coding unit, and ctb_top_boundary denotes the top boundary of the CTU or CTB.

Clause 68. The method of any of clauses 65-67, wherein determining the first number comprises: in accordance with a determination that the coding unit does not locate at the top boundary, determining the first number based on the first distance.

Clause 69. The method of any of clauses 65-68, further comprising: in accordance with a determination that the coding unit locates at the top boundary, determining a first predefined constant as the first number.

Clause 70. The method of clause 69, wherein the first predefined constant comprises one of: 1, 2, 3, 4 or a further constant.

Clause 71. The method of clause 69 or clause 70, wherein the first predefined constant is different from a first threshold number of rows of the neighbor coded block.

Clause 72. The method of clause 67 or clause 71, wherein the first threshold number comprises a constant.

Clause 73. The method of clause 64, further comprising: determining a first number of rows in the set of rows based on a second predefined constant.

Clause 74. The method of clause 73, wherein determining the first number based on the second predefined constant comprises: in accordance with a determination that the coding unit does not locate or locates at a top boundary of a coding tree unit (CTU) or coding tree block (CTB), determining the first number based on the second predefined constant.

Clause 75. The method of clause 74, wherein the coding unit comprises one of the following: a current prediction unit (PU), a current transform unit (TU), a current coding unit (CU), or a current subblock.

Clause 76. The method of any of clauses 73-75, wherein the second predefined constant is greater than 1.

Clause 77. The method of clause 64, further comprising: determining a second number of columns in the set of columns based on a second distance between a coding unit and a left boundary of a current coding tree unit (CTU) or between the coding unit and a left boundary of a current coding tree block (CTB).

Clause 78. The method of clause 77, wherein the coding unit comprises one of the following: a current prediction unit (PU), a current transform unit (TU), a current coding unit (CU), or a current subblock.

Clause 79. The method of clause 77 or clause 78, wherein determining the second number comprises: determining the second number by subtracting the second distance from a second threshold number of columns of the neighbor coded block, wherein the second distance is determined by using DD=func(curblk, ctb_left_boundary), where DD denotes the second difference, func( ) denotes a distance metric, curblk denotes the coding unit, and ctb_left_boundary denotes the left boundary of the CTU or CTB.

Clause 80. The method of any of clauses 77-79, wherein determining the second number comprises: in accordance with a determination that the coding unit does not locate at the left boundary, determining the second number based on the second distance.

Clause 81. The method of any of clauses 77-80, further comprising: in accordance with a determination that the coding unit locates at the left boundary, determining a third predefined constant as the second number.

Clause 82. The method of clause 81, wherein the third predefined constant comprises one of: 1, 2, 3, 4 or a further constant.

Clause 83. The method of clause 81 or clause 82, wherein the third predefined constant is different from a second threshold number of columns of the neighbor coded block.

Clause 84. The method of clause 79 or clause 83, wherein the second threshold number comprises a constant.

Clause 85. The method of clause 64, further comprising: determining a second number of columns in the set of columns based on a fourth predefined constant.

Clause 86. The method of clause 85, wherein determining the second number based on the fourth predefined constant comprises: in accordance with a determination that the coding unit does not locate or locates at a left boundary of a coding tree unit (CTU) or coding tree block (CTB), determining the second number based on the fourth predefined constant.

Clause 87. The method of clause 86, wherein the coding unit comprises one of the following: a current prediction unit (PU), a current transform unit (TU), a current coding unit (CU), or a current subblock.

Clause 88. The method of any of clauses 85-87, wherein the fourth predefined constant is greater than 1.

Clause 89. The method of any of clauses 64-88, wherein performing the conversion comprises: determining whether a candidate of at least one coding unit in the region of the neighbor coded block is valid; determining a third number of valid candidates; and in accordance with a determination that the third number meets a predefined value, performing the conversion based on the third number of valid candidates.

Clause 90. The method of clause 89, wherein the at least one coding unit comprises at least one of the following: a current prediction unit (PU), a current transform unit (TU), a current coding unit (CU), or a current subblock.

Clause 91. The method of clause 89, wherein determining the third number of valid candidates comprises: determining the third number by using a similarity check.

Clause 92. The method of any of clauses 64-91, wherein determining the coding information comprises: sorting motion candidates or mode candidates of the region of the neighbor coded block; and determining the coding information based on the sorting.

Clause 93. The method of clause 92, wherein sorting the motion candidates or mode candidates comprises: sorting the motion candidates or mode candidates by using an adaptive reordering-based coding tool.

Clause 94. The method of clause 93, wherein the adaptive reordering-based coding tool comprises an adaptive reordering merge candidates (ARMC) coding tool.

Clause 95. A method for video processing, comprising: determining, during a conversion between a target video block of a video and a bitstream of the video, information regarding a template-based coding tool based on a position of the target video block; and performing the conversion based on the information.

Clause 96. The method of clause 95, wherein the information comprises at least one of the following: whether to apply the template-based coding tool, or how to apply the template-based coding tool.

Clause 97. The method of clause 95 or clause 96, wherein determining the information comprises: in accordance with a determination that the target video block is at an above or left boundary of a coding unit, determining the information to indicate one of the following: not to use the template-based coding tool, or to use the template-based coding tool.

Clause 98. The method of clause 95 or clause 96, wherein determining the information comprises: in accordance with a determination that the target video block is at an above boundary of a coding unit, determining the information to indicate one of the following: that samples above the target video block are absent from a template for the target video block, or that the template comprises the samples above the target video block.

Clause 99. The method of clause 95 or clause 96, wherein determining the information comprises: in accordance with a determination that the target video block is at a left boundary of a coding unit, determining the information to indicate one of the following: that samples left to the target video block are absent from a template for the target video block, or that the template comprises the samples left to the target video block.

Clause 100. The method of any of clauses 97-99, wherein the coding unit comprises one of: a coding tree unit (CTU), a virtual pipeline data unit (VPDU), or a coding region.

Clause 101. A method for video processing, comprising: determining, during a conversion between a target video block of a video and a bitstream of the video, at least one history-based information table of the target video block; and performing the conversion based on the at least one history-based information table.

Clause 102. The method of clause 101, wherein the at least one history-based information table is maintained for the target video block.

Clause 103. The method of clause 101 or clause 102, wherein the at least one history-based information table comprises a history-based intra mode table.

Clause 104. The method of clause 103, further comprising: updating the history-based intra mode table on-the-fly with decoded block intra mode information.

Clause 105. The method of clause 103 or clause 104, further comprising: adding a new candidate to the history-based intra mode table by using at least one of the following procedures: a pruning procedure, a redundancy check procedure, or a similarity check procedure.

Clause 106. The method of any of clauses 103-105, further comprising: maintaining the history-based intra mode table for coding blocks in a current picture.

Clause 107. The method of clause 106, wherein maintaining the history-based intra mode table comprises: maintaining a first number of intra mode candidates from a previously coded block in the current picture in the history-based intra mode table.

Clause 108. The method of any of clauses 103-107, further comprising: maintaining the history-based intra mode table for coding blocks in a reference picture.

Clause 109. The method of clause 108, wherein maintaining the history-based intra mode table comprises: maintaining a second number of intra mode candidates from an identified block in the reference picture in the history-based intra mode table.

Clause 110. The method of any of clauses 103-109, wherein performing the conversion comprises: determining a most probable mode (MPM) list of the target video block being intra coded based on at least one intra mode in the history-based intra mode table.

Clause 111. The method of clause 110, further comprising: selecting the at least one intra mode from the history-based intra mode table based on a rule.

Clause 112. The method of clause 111, wherein a number of intra mode of the at least one intra mode comprises a predefined number.

Clause 113. The method of clause 110, further comprising: sorting a plurality of intra mode candidates in the history-based intra mode table; and selecting the at least one intra mode from the history-based intra mode table based on the sorting.

Clause 114. The method of clause 113, wherein sorting the plurality of intra mode candidates comprises: sorting the plurality of intra mode candidates by using a template-based tool.

Clause 115. The method of any of clauses 103-114, wherein an intra mode in the history-based intra mode table is a predefined mode for the target video block being intra coded.

Clause 116. The method of clause 101 or clause 102, wherein the at least one history-based information table comprises a history-based partition information table.

Clause 117. The method of clause 116, further comprising: updating the history-based partition information table on-the-fly with decoded partition information.

Clause 118. The method of clause 117, wherein the decoded partition information comprises decoded partition information for at least one of the following: a coding unit (CU), a prediction unit (PU), a transform unit (TU), a coding tree unit (CTU), a coding block (CB), a prediction block (PB), a transform block (TB), or a coding tree block (CTB).

Clause 119. The method of clause 117 or clause 118, wherein the decoded partition information comprises at least one of: partition information of a previously coded block in a current picture, or partition information of a temporally coded block in a reference picture.

Clause 120. The method of any of clauses 116-119, further comprising: adding a new candidate in the history-based partition information table by using at least one of the following procedures: a pruning procedure, a redundancy check procedure, or a similarity check procedure.

Clause 121. The method of any of clauses 116-120, wherein a candidate in the history-based partition information table comprises at least one of the following: a partition depth, a size of coding tree node, or splitting tree information.

Clause 122. The method of clause 121, wherein the partition depth comprises at least one of: a quadtree (QT) depth or a multi-type tree (MTT) depth.

Clause 123. The method of clause 121, wherein the splitting tree information comprises at least one of: binary tree (BT) or ternary tree (TT) splitting, or vertical or horizontal at a depth.

Clause 124. The method of any of clauses 116-123, wherein performing the conversion comprises: determining partition information of the target video block based on a candidate index in the history-based partition information table; and performing the conversion based on the partition information.

Clause 125. The method of clause 124, wherein the target video block comprises a coding tree node.

Clause 126. The method of clause 124 or clause 125, further comprising: including the candidate index in the bitstream.

Clause 127. The method of clause 124 or clause 125, wherein the partition information of the target video block is not directly included in the bitstream.

Clause 128. The method of any of clauses 116-127, further comprising: indicating whether to use the history-based partition information table in the conversion in the bitstream.

Clause 129. The method of clause 128, wherein whether to use the history-based partition information table is indicated in a block-based syntax element.

Clause 130. The method of clause 129, wherein the block-based syntax element comprises at least one of: a flag, or a mode index.

Clause 131. The method of any of clauses 128-130, wherein whether to use the history-based partition information table comprises one of: whether to include the partition information of the target video block in the bitstream or determine the partition information of the target video block by using the history-based partition information table.

Clause 132. The method any of clauses 128-131, wherein whether to use the history-based partition information table is indicated in at least one of the following: a sequence parameter set (SPS) flag, a Picture Parameter Set (PPS) flag, a picture header (PH) flag, a slice header (SH) flag, a coding tree unit (CTU) flag, or a coding tree block (CTB) flag.

Clause 133. The method of clause 132, wherein whether to use the history-based partition information table comprises an allowance of using the history-based partition information table at a video unit level higher than the target video block.

Clause 134. The method of any of clauses 1-133, further comprising: indicating second information on whether to and/or how to apply the method in the bitstream.

Clause 135. The method of clause 134, wherein the second information is indicated at one of: a sequence level, a group of pictures level, a picture level, a slice level or a tile group level.

Clause 136. The method of clause 134 or clause 135, wherein the second information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 137. The method of any of clauses 134-136, wherein the second information is indicated in a region containing more than one sample or pixel.

Clause 138. The method of clause 137, wherein the region comprising one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 139. The method of any of clauses 134-138, wherein the second information depends on coded information.

Clause 140. The method of clause 139, wherein the coded information comprises at least one of: a coding mode, a block size, a colour format, a single or dual tree partitioning, a colour component, a slice type, or a picture type.

Clause 141. The method of any of clauses 1-140, wherein the conversion includes encoding the target video block into the bitstream.

Clause 142. The method of any of clauses 1-140, wherein the conversion includes decoding the target video block from the bitstream.

Clause 143. An apparatus for processing video data comprising a processor and a non-transitory memory with instructions thereon, wherein the instructions upon execution by the processor, cause the processor to perform a method in accordance with any of clauses 1-142.

Clause 144. A non-transitory computer-readable storage medium storing instructions that cause a processor to perform a method in accordance with any of clauses 1-142.

Clause 145. A non-transitory computer-readable recording medium storing a bitstream of a video which is generated by a method performed by a video processing apparatus, wherein the method comprises: determining a first prediction of a target video block of the video by using an inter prediction tool; determining a second prediction by performing a motion compensation process on the first prediction; obtaining a third prediction by performing a forward mapping process on the second prediction; and generating the bitstream based on the third prediction.

Clause 146. A method for storing a bitstream of a video, comprising: determining a first prediction of a target video block of the video by using an inter prediction tool; determining a second prediction by performing a motion compensation process on the first prediction; obtaining a third prediction by performing a forward mapping process on the second prediction; generating the bitstream based on the third prediction; and storing the bitstream in a non-transitory computer-readable recording medium.

Clause 147. A non-transitory computer-readable recording medium storing a bitstream of a video which is generated by a method performed by a video processing apparatus, wherein the method comprises: determining a first prediction of a target video block of the video by using an inter prediction tool; obtaining a second prediction by performing a forward mapping process on the first prediction to a reshaped domain; obtaining a third prediction by performing a processing procedure on the second prediction; determining a fourth prediction by performing a motion compensation process at least on the third prediction; and generating the bitstream based on the fourth prediction.

Clause 148. A method for storing a bitstream of a video, comprising: determining a first prediction of a target video block of the video by using an inter prediction tool; obtaining a second prediction by performing a forward mapping process on the first prediction to a reshaped domain; obtaining a third prediction by performing a processing procedure on the second prediction; determining a fourth prediction by performing a motion compensation process at least on the third prediction; generating the bitstream based on the fourth prediction; and storing the bitstream in a non-transitory computer-readable recording medium.

Clause 149. A non-transitory computer-readable recording medium storing a bitstream of a video which is generated by a method performed by a video processing apparatus, wherein the method comprises: determining a first prediction of a target video block of the video by using an intra prediction tool; obtaining a second prediction by performing an inverse mapping process on the first prediction to an original domain; obtaining a third prediction by performing a processing procedure on the second prediction; determining a fourth prediction by performing a motion compensation process on the third prediction; and generating the bitstream based on the fourth prediction.

Clause 150. A method for storing a bitstream of a video, comprising: determining a first prediction of a target video block of the video by using an intra prediction tool; obtaining a second prediction by performing an inverse mapping process on the first prediction to an original domain; obtaining a third prediction by performing a processing procedure on the second prediction; determining a fourth prediction by performing a motion compensation process on the third prediction; generating the bitstream based on the fourth prediction; and storing the bitstream in a non-transitory computer-readable recording medium.

Clause 151. A non-transitory computer-readable recording medium storing a bitstream of a video which is generated by a method performed by a video processing apparatus, wherein the method comprises: determining a plurality of template matching tools for a target video block of the video; applying at least one of the plurality of template matching tools to the target video block; and generating the bitstream based on the applying.

Clause 152. A method for storing a bitstream of a video, comprising: determining a plurality of template matching tools for a target video block of the video; applying at least one of the plurality of template matching tools to the target video block; generating the bitstream based on the applying; and storing the bitstream in a non-transitory computer-readable recording medium.

Clause 153. A non-transitory computer-readable recording medium storing a bitstream of a video which is generated by a method performed by a video processing apparatus, wherein the method comprises: determining coding information of a neighboring coded block of a target video block of the video; and generating the bitstream based on the coding information.

Clause 154. A method for storing a bitstream of a video, comprising: determining coding information of a neighboring coded block of a target video block of the video; generating the bitstream based on the coding information; and storing the bitstream in a non-transitory computer-readable recording medium.

Clause 155. A non-transitory computer-readable recording medium storing a bitstream of a video which is generated by a method performed by a video processing apparatus, wherein the method comprises: determining information regarding a template-based coding tool based on a position of a target video block of the video; and generating the bitstream based on the information.

Clause 156. A method for storing a bitstream of a video, comprising: determining information regarding a template-based coding tool based on a position of a target video block of the video; generating the bitstream based on the information; and storing the bitstream in a non-transitory computer-readable recording medium.

Clause 157. A non-transitory computer-readable recording medium storing a bitstream of a video which is generated by a method performed by a video processing apparatus, wherein the method comprises: determining at least one history-based information table of a target video block of the video; and generating the bitstream based on the at least one history-based information table.

Clause 158. A method for storing a bitstream of a video, comprising: determining at least one history-based information table of a target video block of the video; generating the bitstream based on the at least one history-based information table; and storing the bitstream in a non-transitory computer-readable recording medium.

### Example Device

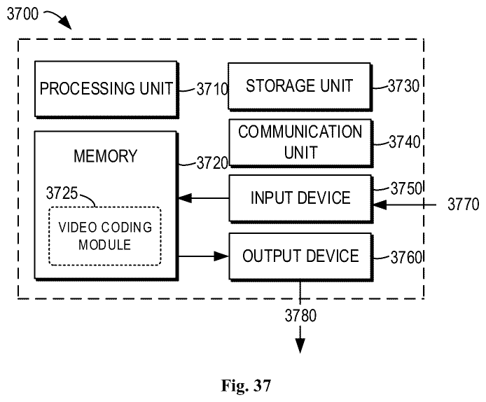

FIG. 37 illustrates a block diagram of a computing device 3700 in which various embodiments of the present disclosure can be implemented. The computing device 3700 may be implemented as or included in the source device 110 (or the video encoder 114 or 200) or the destination device 120 (or the video decoder 124 or 300).

It would be appreciated that the computing device 3700 shown in FIG. 37 is merely for purpose of illustration, without suggesting any limitation to the functions and scopes of the embodiments of the present disclosure in any manner.

As shown in FIG. 37, the computing device 3700 includes a general-purpose computing device 3700. The computing device 3700 may at least comprise one or more processors or processing units 3710, a memory 3720, a storage unit 3730, one or more communication units 3740, one or more input devices 3750, and one or more output devices 3760.

In some embodiments, the computing device 3700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3700 can support any type of interface to a user (such as “wearable” circuitry and the like).

The processing unit 3710 may be a physical or virtual processor and can implement various processes based on programs stored in the memory 3720. In a multi-processor system, multiple processing units execute computer executable instructions in parallel so as to improve the parallel processing capability of the computing device 3700. The processing unit 3710 may also be referred to as a central processing unit (CPU), a microprocessor, a controller or a microcontroller.

The computing device 3700 typically includes various computer storage medium. Such medium can be any medium accessible by the computing device 3700, including, but not limited to, volatile and non-volatile medium, or detachable and non-detachable medium. The memory 3720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3730 may be any detachable or non-detachable medium and may include a machine-readable medium such as a memory, flash memory drive, magnetic disk or another other media, which can be used for storing information and/or data and can be accessed in the computing device 3700.

The computing device 3700 may further include additional detachable/non-detachable, volatile/non-volatile memory medium. Although not shown in FIG. 37, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3740 communicates with a further computing device via the communication medium. In addition, the functions of the components in the computing device 3700 can be implemented by a single computing cluster or multiple computing machines that can communicate via communication connections. Therefore, the computing device 3700 can operate in a networked environment using a logical connection with one or more other servers, networked personal computers (PCs) or further general network nodes.

The input device 3750 may be one or more of a variety of input devices, such as a mouse, keyboard, tracking ball, voice-input device, and the like. The output device 3760 may be one or more of a variety of output devices, such as a display, loudspeaker, printer, and the like. By means of the communication unit 3740, the computing device 3700 can further communicate with one or more external devices (not shown) such as the storage devices and display device, with one or more devices enabling the user to interact with the computing device 3700, or any devices (such as a network card, a modem and the like) enabling the computing device 3700 to communicate with one or more other computing devices, if required. Such communication can be performed via input/output (I/O) interfaces (not shown).

In some embodiments, instead of being integrated in a single device, some or all components of the computing device 3700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3700 may be used to implement video encoding/decoding in embodiments of the present disclosure. The memory 3720 may include one or more video coding modules 3725 having one or more program instructions. These modules are accessible and executable by the processing unit 3710 to perform the functionalities of the various embodiments described herein.

In the example embodiments of performing video encoding, the input device 3750 may receive video data as an input 3770 to be encoded. The video data may be processed, for example, by the video coding module 3725, to generate an encoded bitstream. The encoded bitstream may be provided via the output device 3760 as an output 3780.

In the example embodiments of performing video decoding, the input device 3750 may receive an encoded bitstream as the input 3770. The encoded bitstream may be processed, for example, by the video coding module 3725, to generate decoded video data. The decoded video data may be provided via the output device 3760 as the output 3780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a target video block of a video and a bitstream of the video, first information comprising at least one of: coding information of a neighboring coded block of the target video block, information regarding a template-based coding tool based on a position of the target video block, or at least one history-based information table of the target video block; and
performing the conversion based on the first information.

2. The method of claim 1, wherein performing the conversion comprises:
coding the target video block by using one of the following:
an affine merge coding tool,
an affine advanced motion vector predication (AMVP) coding tool,
a regular merge coding tool,
a subblock merge coding tool,
a combined inter and intra prediction (CIIP) coding tool,
a geometric partitioning mode (GPM) coding tool,
an AMVP-merge coding tool,
an intra coding tool, or
a variant of one of the above coding tools,
wherein the first information comprises at least one of:
an intra mode of the neighbor coded block,
an inter prediction coding tool of the neighbor coded block,
a motion vector of the neighbor coded block,
a reference index of the neighbor coded block,
a prediction direction of the neighbor coded block,
a coordinator of the neighbor coded block, or
a location of the neighbor coded block.

3. The method of claim 2, further comprising:
determining a size or dimension of the neighbor coded block based on a size or dimension of a coding unit;
wherein the coding unit comprises one of:
a prediction unit (PU),
a transform unit (TU),
a coding unit (CU),
a subblock, or
a fixed granular unit,
wherein the fixed granular unit comprises one of:
a 4 times 4 unit,
an eight times eight unit, or
a sixteen times sixteen unit.

4. The method of claim 1, wherein the coding information comprises the coding information of a region of the neighbor coded block, the region comprises at least one of:
a set of rows of the neighbor coded block, or
a set of columns of the neighbor coded block.

5. The method of claim 4, further comprising:
determining a first number of rows in the a of rows based on a first distance between a coding unit and a top boundary of a current coding tree unit (CTU) or between the coding unit and a top boundary of a current coding tree block (CTB); and
determining a first number of rows in the set of rows based on a second predefined constant.

6. The method of claim 5, wherein the coding unit comprises one of:
a current prediction unit (PU),
a current transform unit (TU),
a current coding unit (CU), or
a current subblock,
wherein determining the first number comprises: determining the first number by subtracting the first distance from a first threshold number of rows of the neighbor coded block,
wherein the first distance is determined by using D=func(curblk, ctb_top_boundary), where D denotes the first difference, func( ) denotes a distance metric, curblk denotes the coding unit, and ctb_top_boundary denotes the top boundary of the CTU or CTB,
wherein determining the first number comprises: in accordance with a determination that the coding unit does not locate at the top boundary, determining the first number based on the first distance; and in accordance with a determination that the coding unit locates at the top boundary, determining a first predefined constant as the first number,
wherein the first predefined constant comprises one of: 1, 2, 3, 4 or a further constant,
wherein the first predefined constant is different from a first threshold number of rows of the neighbor coded block,
wherein the first threshold number comprises a constant;
wherein determining the first number based on the second predefined constant comprises: in accordance with a determination that the coding unit does not locate or locates at a top boundary of a coding tree unit (CTU) or coding tree block (CTB), determining the first number based on the second predefined constant,
wherein the coding unit comprises one of:
a current prediction unit (PU),
a current transform unit (TU),
a current coding unit (CU), or
a current subblock,
wherein the second predefined constant is greater than 1.

7. The method of claim 4, further comprising:
determining a second number of columns in the a of columns based on a second distance between a coding unit and a left boundary of a current coding tree unit (CTU) or between the coding unit and a left boundary of a current coding tree block (CTB); and
determining a second number of columns in the set of columns based on a fourth predefined constant.

8. The method of claim 7, wherein the coding unit comprises one of:
a current prediction unit (PU),
a current transform unit (TU),
a current coding unit (CU), or
a current subblock,
wherein determining the second number comprises: determining the second number by subtracting the second distance from a second threshold number of columns of the neighbor coded block,
wherein the second distance is determined by using DD=func(curblk, ctb_left_boundary), where DD denotes the second difference, func( ) denotes a distance metric, curblk denotes the coding unit, and ctb_left_boundary denotes the left boundary of the CTU or CTB,
wherein determining the second number comprises: in accordance with a determination that the coding unit does not locate at the left boundary, determining the second number based on the second distance; and in accordance with a determination that the coding unit locates at the left boundary, determining a third predefined constant as the second number,
wherein the third predefined constant comprises one of: 1, 2, 3, 4 or a further constant,
wherein the third predefined constant is different from a second threshold number of columns of the neighbor coded block,
wherein the second threshold number comprises a constant; and
wherein determining the second number based on the fourth predefined constant comprises: in accordance with a determination that the coding unit does not locate or locates at a left boundary of a coding tree unit (CTU) or coding tree block (CTB), determining the second number based on the fourth predefined constant,
wherein the coding unit comprises one of:
a current prediction unit (PU),
a current transform unit (TU),
a current coding unit (CU), or
a current subblock,
wherein the fourth predefined constant is greater than 1.

9. The method of claim 3, wherein performing the conversion comprises:
determining whether a candidate of at least one coding unit in the region of the neighbor coded block is valid; and
determining a third number of valid candidates, wherein the conversion is performed, in accordance with a determination that the third number meets a predefined value, based on the third number of valid candidates.

10. The method of claim 9, wherein the at least one coding unit comprises at least one of:
a current prediction unit (PU),
a current transform unit (TU),
a current coding unit (CU), or
a current subblock,
wherein determining the third number of valid candidates comprises: determining the third number by using a similarity check,
wherein determining the coding information comprises: sorting motion candidates or mode candidates of the region of the neighbor coded block; and determining the coding information based on the sorting,
wherein sorting the motion candidates or mode candidates comprises: sorting the motion candidates or mode candidates by using an adaptive reordering-based coding tool,
wherein the adaptive reordering-based coding tool comprises an adaptive reordering merge candidates (ARMC) coding tool.

11. The method of claim 1, wherein the information regarding a template-based coding tool comprises at least one of: whether to apply the template-based coding tool, or how to apply the template-based coding tool.

12. The method of claim 11, wherein determining the information comprises:
in accordance with a determination that the target video block is at an above or left boundary of a coding unit, determining the information to indicate one of: not to use the template-based coding tool, or to use the template-based coding tool,
wherein determining the information comprises:
in accordance with a determination that the target video block is at an above boundary of a coding unit, determining the information to indicate one of:
that samples above the target video block are absent from a template for the target video block, or
that the template comprises the samples above the target video block,
wherein determining the information comprises:
in accordance with a determination that the target video block is at a left boundary of a coding unit, determining the information to indicate one of:
that samples left to the target video block are absent from a template for the target video block, or
that the template comprises the samples left to the target video block,
wherein the coding unit comprises one of: a coding tree unit (CTU), a virtual pipeline data unit (VPDU), or a coding region.

13. The method of claim 1, wherein the at least one history-based information table is maintained for the target video block, or
wherein the at least one history-based information table comprises a history-based intra mode table.

14. The method of claim 13, further comprising:
updating the history-based intra mode table on-the-fly with decoded block intra mode information;
adding a new candidate to the history-based intra mode table by using at least one of the following procedures: a pruning procedure, a redundancy check procedure, or a similarity check procedure; and
maintaining the history-based intra mode table for coding blocks in a current picture,
wherein maintaining the history-based intra mode table comprises: maintaining a first number of intra mode candidates from a previously coded block in the current picture in the history-based intra mode table; and maintaining the history-based intra mode table for coding blocks in a reference picture, or
wherein maintaining the history-based intra mode table comprises: maintaining a second number of intra mode candidates from an identified block in the reference picture in the history-based intra mode table.

15. The method of claim 14, wherein performing the conversion comprises:
determining a most probable mode (MPM) list of the target video block being intra coded based on at least one intra mode in the history-based intra mode table;
selecting the at least one intra mode from the history-based intra mode table based on a rule, wherein a number of intra mode of the at least one intra mode comprises a predefined number;
sorting a plurality of intra mode candidates in the history-based intra mode table; and
selecting the at least one intra mode from the history-based intra mode table based on the sorting,
wherein sorting the plurality of intra mode candidates comprises: sorting the plurality of intra mode candidates by using a template-based tool,
wherein an intra mode in the history-based intra mode table is a predefined mode for the target video block being intra coded.

16. The method of claim 1, wherein the conversion includes encoding the target video block into the bitstream.

17. The method of claim 1, wherein the conversion includes decoding the target video block from the bitstream.

18. An apparatus for processing video data comprising a processor and a non-transitory memory with instructions thereon, wherein the instructions upon execution by the processor, cause the processor to:
determine, during a conversion between a target video block of a video and a bitstream of the video, first information comprising at least one of: coding information of a neighboring coded block of the target video block, information regarding a template-based coding tool based on a position of the target video block, or at least one history-based information table of the target video block; and
perform the conversion based on the coding first information.

19. A non-transitory computer-readable storage medium storing instructions that cause a processor to perform a method performed by a video processing apparatus, wherein the method comprises:
determining, during a conversion between a target video block of a video and a bitstream of the video, first information comprising at least one of: coding information of a neighboring coded block of the target video block, information regarding a template-based coding tool based on a position of the target video block, or at least one history-based information table of the target video block; and
performing the conversion based on the coding first information.

20. A non-transitory computer-readable recording medium storing a bitstream of a video which is generated by a method performed by a video processing apparatus, wherein the method comprises:
determining first information comprising at least one of: coding information of a neighboring coded block of a target video block of the video, information regarding a template-based coding tool based on a position of the target video block, or at least one history-based information table of the target video block; and
generating the bitstream based on the coding first information.
